(19) United States
(12) Patent Application Publication
(10) Pub. No.: US 2015/0029196 A1
(43) Pub. Date: Jan. 29, 2015

(54) DISTRIBUTION MANAGEMENT APPARATUS

(71) Applicants: Haruo Shida, Kanagawa (JP); Kiyoshi Kasatani, Kanagawa (JP); Yuichi Kawasaki, Kanagawa (JP)

(72) Inventors: Haruo Shida, Kanagawa (JP); Kiyoshi Kasatani, Kanagawa (JP); Yuichi Kawasaki, Kanagawa (JP)

(21) Appl. No.: 14/338,517

(22) Filed: Jul. 23, 2014

(30) Foreign Application Priority Data
Jul. 25, 2013 (JP) 2013-154785
Sep. 25, 2013 (JP) 2013-199004
Apr. 18, 2014 (JP) 2014-086773

(51) Int. Cl. G06T 11/20

(52) U.S. Cl. CPC G06T 11/203; G06T 2200/16
USPC 345/443

(57) ABSTRACT

A distribution management apparatus includes: a receiving unit that receives operation information, which indicates operation input that a terminal has accepted, from the terminal via a network; a browser that creates drawing information to be displayed on the terminal from the operation information; an encoder that encodes the drawing information; and a transmitting unit that transmits the encoded drawing information to the terminal.

### CROSS-REFERENCE TO RELATED APPLICATIONS

The present application claims priority to and incorporates by reference the entire contents of Japanese Patent Application No. 2013-154785 filed in Japan on Jul. 25, 2013, Japanese Patent Application No. 2013-199004 filed in Japan on Sep. 25, 2013, and Japanese Patent Application No. 2014-086773 filed in Japan on Apr. 18, 2014.

### BACKGROUND OF THE INVENTION

1. Field of the Invention

The present invention relates to a distribution management apparatus.

2. Description of the Related Art

Conventionally, electronic information boards capable of displaying a background image on a large-screen display and enabling a user to write down a drawing image, such as a character, a number, and a graphic, on the background image have been used in meetings of business enterprises, educational institutions, administrative agencies, and the like. Such an electronic information board has an enlarged display function of displaying an enlarged image of an image displayed on a display screen of a personal computer (PC) connected to the electronic information board, a PC operating function of operating the connected PC through a touch panel function built into the electronic information board, and an electronic blackboard function of displaying a drawn image such as a character handwritten by a user on the touch panel likened to a blackboard in a manner superimposed on the PC display image, or the like Through the use of such an electronic information board, for example, in an office meeting, a user can directly write down points of note or the like in a display image while performing an operation to display explanatory materials on the electronic information board, and can record a drawn image written down on the electronic information board. Accordingly, it is possible to reuse the drawn image to summarize contents of the meeting efficiently.

Incidentally, Japanese Patent No. 4696480 has disclosed a technique to store history data of memos handwritten on an electronic blackboard and overwritten on materials were written down in a server, thereby enabling to display drawn images on electronic blackboards set in multiple bases of a remote meeting, in a superimposed manner.

However, to cause electronic information boards to operate as electronic blackboards in multiple bases of a remote meeting, the electronic information boards are required to have a high software processing capacity, which results in an increase in cost of equipment. Meanwhile, according to a technique as disclosed in Japanese Patent No. 4696480 in which software processing is performed by an external server, going through a network causes a delay in processing, and therefore displaying of a handwritten drawn image is delayed, which impedes the progress of a meeting.

In view of the above, there is a need to provide a distribution management apparatus capable of displaying, on a terminal, a drawn image handwritten by a user without delay at low cost.

### SUMMARY OF THE INVENTION

It is an object of the present invention to at least partially solve the problems in the conventional technology.

A distribution management apparatus includes: a receiving unit that receives operation information, which indicates operation input that a terminal has accepted, from the terminal via a network; a browser that creates drawing information to be displayed on the terminal from the operation information; an encoder that encodes the drawing information; and a transmitting unit that transmits the encoded drawing information to the terminal.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a schematic diagram showing a schematic configuration of an image processing system according to a first embodiment;

FIG. 2 is a block diagram showing a schematic configuration of an image processing apparatus according to the first embodiment;

FIG. 3 is a schematic diagram illustrating components of image data created by an image processing server according to the first embodiment;

FIG. 4 is a flowchart illustrating a procedure for image processing by the image processing apparatus according to the first embodiment;

FIG. 5 is a schematic diagram of a distribution system according to a second embodiment;

FIG. 6 is a conceptual diagram showing a basic distribution method;

FIG. 7 is a conceptual diagram of multicast;

FIG. 8 is a conceptual diagram of composite distribution using multiple communication terminals through a distribution management apparatus;

FIG. 9 is a diagram showing an example of a hardware configuration of the distribution management apparatus;

FIG. 10 is a functional block diagram showing mainly functions of the distribution management apparatus;

FIG. 11 is a functional block diagram showing mainly functions of the communication terminal;

FIG. 12 is a functional block diagram showing functions of a terminal management apparatus;

FIG. 13 is a conceptual diagram of a distribution-destination selection menu screen;

FIG. 14 is a conceptual diagram of a terminal management table;

FIG. 15 is a conceptual diagram of an available-terminal management table;

FIG. 16 is a conceptual diagram showing an example of drawing information;

FIG. 17 is a diagram showing correspondence of the drawing information shown in FIG. 16 to the display screen of a communication terminal;

FIG. 18 is a conceptual diagram showing an example of electronic pen information;

FIG. 19 is a detail view of an encoder bridge unit;

FIG. 20 is a functional block diagram showing functions of a converting unit;

FIG. 21 is a sequence diagram showing basic distribution processing by the distribution management apparatus;

FIG. 22 is a sequence diagram showing a remote sharing process using the distribution management apparatus;

FIG. 23 is a flowchart showing an operation-data analyzing process;

FIG. 24 is a diagram showing an example of how the screen area of the communication terminal is used;

FIG. 25 is a sequence diagram showing a time adjusting process performed between the distribution management apparatus and the communication terminal;

FIG. 26 is a sequence diagram showing a process of line adaptive control for data to be transmitted from the distribution management apparatus to the communication terminal; and

FIG. 27 is a sequence diagram showing a process of line adaptive control for data to be transmitted from the communication terminal to the distribution management apparatus.

### DETAILED DESCRIPTION OF THE PREFERRED EMBODIMENTS

### First Embodiment

A distribution management apparatus (an image processing server) according to a first embodiment of the present invention is explained in detail below with reference to accompanying drawings. Incidentally, the present invention is not limited to this embodiment. Furthermore, the identical components are denoted by the same reference numeral in the drawings.

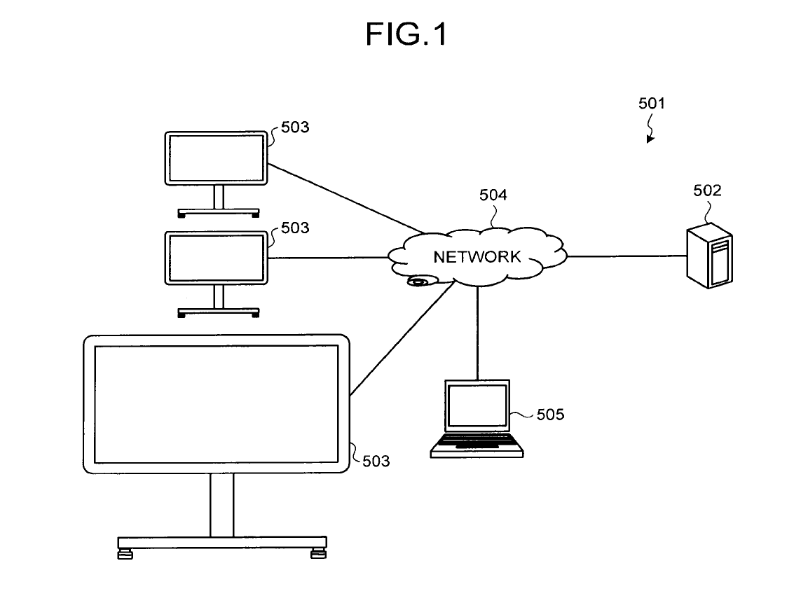

FIG. 1 is a schematic diagram showing a schematic configuration of an image processing system according to the first embodiment. As shown in FIG. 1, an image processing system 501 includes an image processing server 502 and one or more image processing apparatuses (electronic information boards) 503, and these perform data communication with each other via a network 504 such as a LAN and the Internet. Incidentally, the image processing server 502 and the image processing apparatuses 503 can perform data communication with a user PC 5 connected to the network 504.

The image processing server 502 is realized by an information processing apparatus such as a workstation or a general computer, and includes a storage device such as a memory such as a ROM or a RAM, and a recording medium such as a CD-ROM and a hard disk, a communication device, an output device such as a display device and a printer, and an input device. An arithmetic processing unit such as a CPU in the information processing apparatus executes an image processing program stored in the memory, and thereby the image processing server 502 performs image processing to be described later.

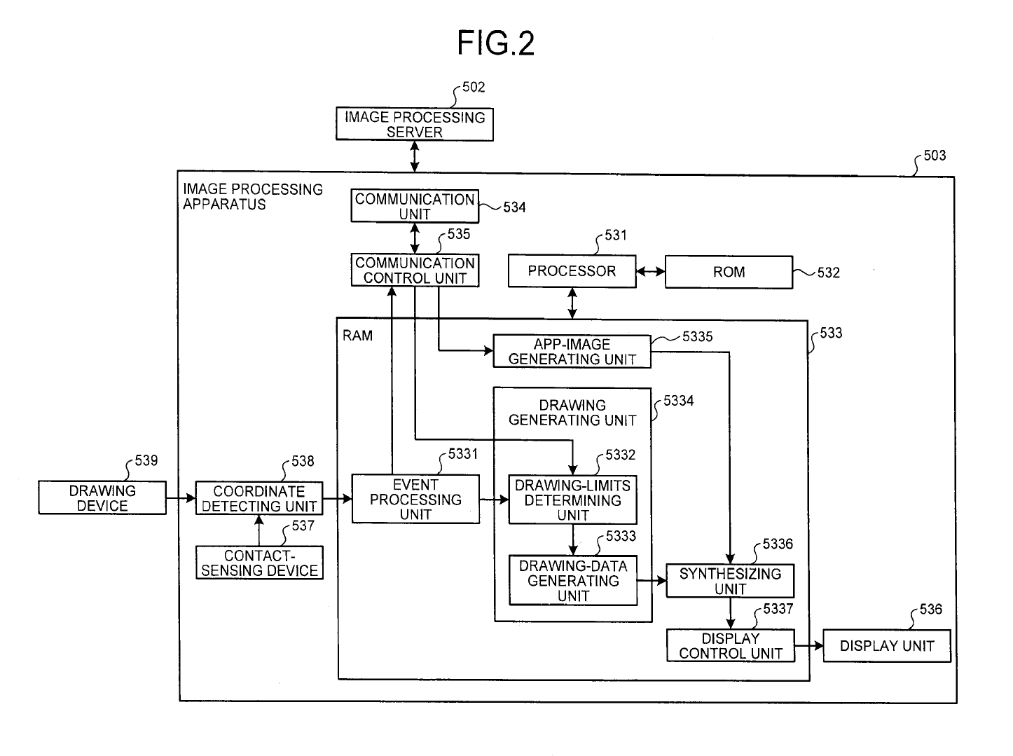

FIG. 2 is a block diagram illustrating a configuration of the image processing apparatus 503 according to the first embodiment. The image processing apparatus 503 is composed of an information processing apparatus such as a workstation or a personal computer (PC). As shown in FIG. 2, the image processing apparatus 503 includes a processor 531, a read-only memory (ROM) 532, a random access memory (RAM) 533, a communication unit 534, a communication control unit 535, a display unit 536, a contact-sensing device 537, a coordinate detecting unit 538, and a drawing device 539.

The drawing device 539 is a pen-shaped device equipped with a contact-sensing unit, which senses contact of a physical body, on the tip thereof, and is used to draw an image while being into contact with the display unit 536. When the contact-sensing unit of the drawing device 539 comes into contact with a physical body, the drawing device 539 transmits a contact signal, which indicates the contact with a physical body, together with identification information of the drawing device 539 to the coordinate detecting unit 538.

Incidentally, the drawing device 539 in the present embodiment is equipped with an erase-mode selector switch for switching from the normal drawing mode to the erase mode on the side surface or rear end thereof. When a user brings the drawing device 539 into contact with the display unit 536 while holding down the erase-mode selector switch of the drawing device 539, the drawing device 539 operates in the erase mode, and transmits a contact signal together with the identification information of the drawing device 539 and mode type information indicating the erase mode to the coordinate detecting unit 538. When the user brings the drawing device 539 into contact with the display unit 536 without holding down the erase-mode selector switch, the drawing device 539 operates in the drawing mode, and transmits a contact signal together with the identification information of the drawing device 539 to the coordinate detecting unit 538. Furthermore, the drawing device 539 can instruct the user to select an object, such as a menu or a button, displayed on the display unit 536. When the user brings the drawing device 539 into contact with an object displayed on the display unit 536 without holding down the erase-mode selector switch, i.e., when a contact position is within a coordinate area of an object, the drawing device 539 operates in the object selection notification mode. In this case, the drawing device 539 transmits a contact signal together with the identification information of the drawing device 539 and mode type information indicating the selection notification mode to the coordinate detecting unit 538.

The contact-sensing device 537 senses contact of a physical body, such as the drawing device 539, with the display unit 536. In the present embodiment, an infrared interruption type touch panel is adopted as the contact-sensing device 537. This contact-sensing device 537, with two light emitting/receiving devices placed at both lower ends of the display unit 536, emits infrared rays in a direction parallel to the display unit 536 and receives infrared rays reflected onto the same light paths by a reflecting member placed around the display unit 536. The contact-sensing device 537 notifies the coordinate detecting unit 538 of identification information of the infrared rays that have been emitted from the two light emitting/receiving devices and interrupted by the physical body. Incidentally, as the contact-sensing device 537, there may be adopted a capacitance type touch panel that senses a change in capacitance thereby detecting contact of a physical body with the display unit 536. Furthermore, a resistive type touch panel that detects contact of a physical body with the display unit 536 from a change in voltage of two corresponding resistance films may be adopted as the contact-sensing device 537. Moreover, an electromagnetic induction type touch panel that senses electromagnetic induction generated by contact of a physical body with the display unit 536 thereby detecting the contact of the physical body with the display unit 536 may be adopted as the contact-sensing device 537.

The coordinate detecting unit 538 identifies a coordinate position corresponding to coordinates of a position at which a physical body has made contact with the display unit 536 on the basis of information notified by the contact-sensing device 537. The coordinate detecting unit 538 in the present embodiment uses identification information of infrared rays notified by the contact-sensing device 537 to calculate the coordinate position of the physical body. Furthermore, when the coordinate detecting unit 538 has received a contact signal from the drawing device 539, the coordinate detecting unit 538 issues an event (a drawing instruction event, a selection notification event, or an erase instruction event) corresponding to operation mode (the drawing mode, the selection notification mode, or the erase mode) of the drawing device 539. This event includes identification information of the drawing device 539 and mode type information indicating the operation mode. The coordinate detecting unit 538 further issues a sub-event in addition to the event. Sub-events issued by the coordinate detecting unit 538 include, for example, a sub-event (TOUCH) which notifies that a physical body has come in contact with or close to the display unit 536, a sub-event (MOVE) which notifies that a contact or close point has moved under a condition where a physical body is kept in contact with or close to the display unit 536, and a sub-event (RELEASE) which notifies that a physical body has separated from the display unit 536. These sub-events each include coordinate position information of the contact or close position.

The communication unit 534 is a network interface with the network 504. The communication control unit 535 transmits information, such as authentication information and event information, to the image processing server 502 through the communication unit 534, and receives image data to be displayed on the display unit 536 from the image processing server 502 through the communication unit 534.

The ROM 532 is a non-volatile memory in which a boot program, such as a BIOS or an EFI, is stored. The RAM 533 is a main memory such as a DRAM or an SRAM, and provides a runspace for execution of an image processing program.

The processor 531 is an arithmetic processing unit such as a CPU or an MPU, and runs an OS, such as Windows® series, UNIX®, Linux®, TRON, ITRON, or μITRON, and executes an image processing program written in a program language, such as assembler, C, C++, Java®, JavaScript®, Perl, Ruby, or Python, under the control of the OS. This processor reads out the image processing program from a hard disk device (not shown) that permanently holds therein a software program and various data, and expands the read image processing program into the RAM 533 and executes the image processing program, thereby the RAM 533 serves as an event processing unit 5331, a drawing generating unit 5334 including a drawing-limits determining unit 5332 and a drawing-data generating unit 5333, an app-image generating unit 5335, a synthesizing unit 5336, and a display control unit 5337. Respective functions of these units are described later.

Incidentally, the image processing program executed by the image processing server 502 and the image processing apparatuses 503 according to the present embodiment is provided by recording the image processing program on a computer-readable recording medium, such as a CD-ROM, a flexible disk (FD), a CD-R, or a digital versatile disk (DVD), in an installable or executable file format.

Furthermore, the image processing program executed by the image processing server 502 and the image processing apparatuses 503 according to the present embodiment may be provided in such a manner that the image processing program is stored on a computer connected to a network such as the Internet so that the image processing program can be downloaded over the network 504. Moreover, the image processing program executed by the image processing server 502 and the image processing apparatuses 503 according to the present embodiment may be provided or distributed over a network such as the Internet. Furthermore, the image processing program according to the present embodiment may be embedded in a ROM or the like in advance.

The image processing program executed by the image processing server 502 and the image processing apparatuses 503 according to the present embodiment is composed of modules including the above-described units (the event processing unit 5331, the drawing generating unit 5334 including the drawing-limits determining unit 5332 and the drawing-data generating unit 5333, the app-image generating unit 5335, the synthesizing unit 5336, and the display control unit 5337). A CPU (a processor) as actual hardware reads out the image processing program from a storage medium and executes the image processing program, thereby the above-described units are loaded onto a main memory, and the units are generated on the main memory. Incidentally, at least some of the units may be realized by hardware such as an integrated circuit (IC).

Image Processing by Image Processing Server

The image processing server 502 distributes image data to some or all of the image processing apparatuses 503 at predetermined frequency, and causes the image processing apparatuses 503 to update an image frame displayed on the display unit 536.

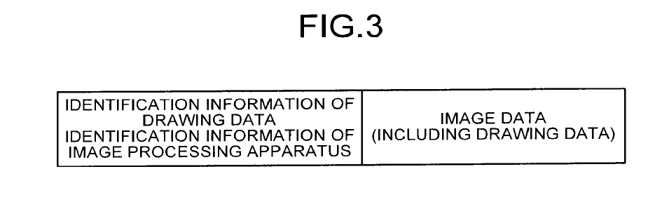

This image data is, as illustrated in FIG. 3, image data of an image formed by importing a drawn image written onto the display unit 536 of one image processing apparatus 503 and a display image of a user PC 505 as a background image of the drawn image and converting these images into a bitmapped image with the image processing server 502 as an image-data creating means. The image processing server 502 acquires a display image from the user PC 505 at predetermined frequency. Furthermore, the image processing server 502 acquires drawing data and identification information of the drawing data from each image processing apparatus 503 as described later. Then, the image processing server 502 synthesizes the acquired display image and drawing data, and creates image data by converting the synthesized image into a bitmapped image. This image data includes identification information of the image processing apparatus 503 and identification information of the drawing data.

Incidentally, this image data may be compressed. In this case, the compressed image data is decompressed in the image processing apparatuses 503 to display the image data on respective display units 536 of the image processing apparatuses 503. Furthermore, when the image processing server 502 has been notified of a selection notification event or an erase instruction event, the image processing server 502 performs image processing according to the notified event.

Image Processing by Image Processing Apparatus

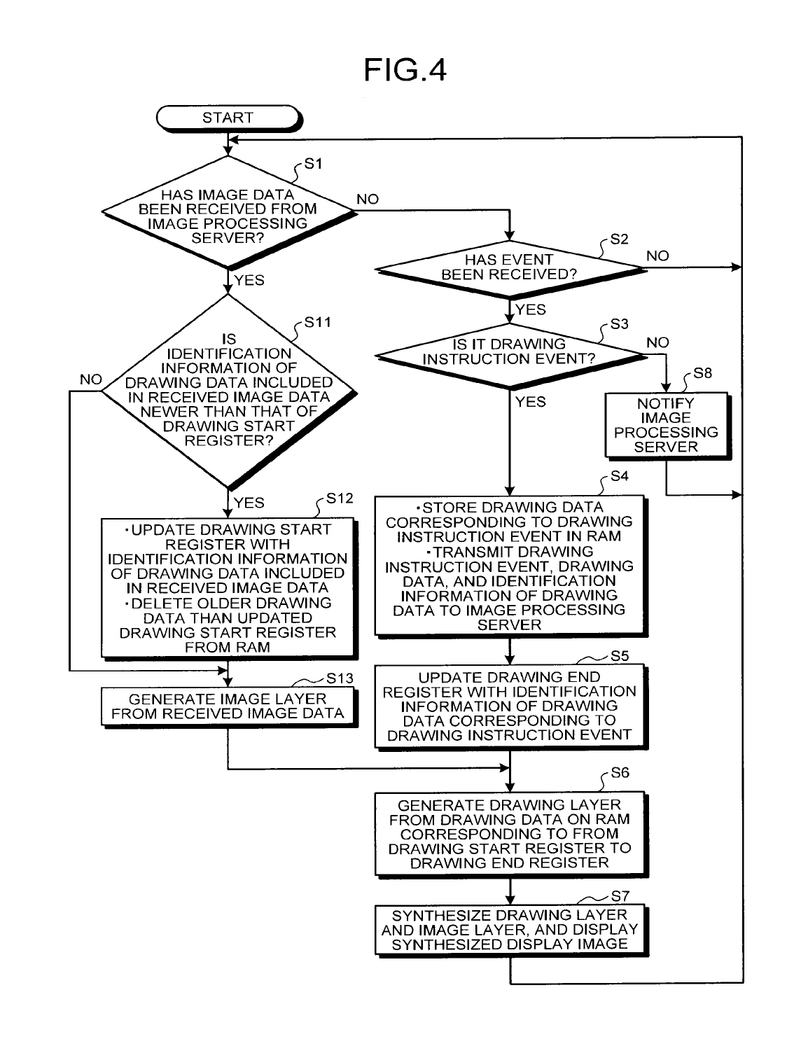

FIG. 4 is a flowchart illustrating a procedure for image processing by the image processing apparatus 503. The image processing shown in FIG. 4 is started, for example, at the timing of user input of an instruction to start using an image processing apparatus 503, and proceeds to a process at Step S1.

In the process at Step S1, it is determined whether the communication control unit 535 has received image data from the image processing server 502. When the communication control unit 535 has received image data (YES at Step S1), the image processing proceeds to a process at Step S11; on the other hand, when the communication control unit 535 has not received image data (NO at Step S1), the image processing proceeds to a process at Step S2.

In the process at Step S2, it is determined whether the event processing unit 5331 has received any event from the coordinate detecting unit 538. When the event processing unit 5331 has not received any event (NO at Step S2), the image processing returns to the process at Step S1 to wait to receive image data or an event; on the other hand, when the event processing unit 5331 has received an event (YES at Step S2), the image processing proceeds to a process at Step S3.

In the process at Step S3, it is determined whether the event received by the event processing unit 5331 is a drawing instruction event. When the received event is a drawing instruction event (YES at Step S3), the image processing proceeds to a process at Step S4. On the other hand, when the received event is not a drawing instruction event, i.e., when the received event is a selection notification event or an erase instruction event (NO at Step S3), the event processing unit 5331 notifies the image processing server 502 of that (Step S8). After that, the image processing returns to the process at Step S1 to wait to receive image data or another event.

Drawing-Data Receiving Process

Subsequently, a drawing-data receiving process (Steps S4 to S7) performed when the event processing unit 5331 has received a drawing instruction event is explained. Through this drawing-data receiving process, a drawn image based on drawing data specified by the received drawing instruction event is displayed on the display unit 536.

In the process at Step S4, the event processing unit 5331 accepts drawing data specified by a sub-event, such as TOUCH, MOVE, or RELEASE, notified together with the drawing instruction event, and stores the drawing data in the RAM 533 in a manner associated with identification information of the drawing data. Furthermore, the event processing unit 5331 transmits the drawing instruction event together with identification information of the image processing apparatus 503, the drawing data, and the identification information of the drawing data to the image processing server 502 through the communication control unit 535. Incidentally, identification information of drawing data is issued for each drawing instruction event, and, for example, a value according to the time at which the drawing instruction event has been received is assigned. In this way, the process at Step S4 is completed, and the image processing proceeds to a process at Step S5.

In the process at Step S5, the drawing-limits determining unit 5332 updates a value of a drawing end register with the identification information of the drawing data issued at Step S4. Here, out of a number of drawing data that have been accepted and stored in the RAM 533 through drawing instruction events received from moment to moment, the limits of drawing data displayed on the display unit 536 is specified by a drawing start register and the drawing end register. The drawing-limits determining unit 5332 sets a value of the drawing end register to identification information of the latest drawing data, thereby the latest drawing data can be displayed on the display unit 536. Incidentally, the drawing-limits determining unit 5332 sets identification information of drawing data corresponding to the first drawing instruction event as an initial value of the drawing start register. In this way, the process at Step S5 is completed, and the image processing proceeds to a process at Step S6.

In the process at Step S6, the drawing-data generating unit 5333 generates a drawing layer of a display image based on drawing data on the RAM 533 corresponding to from the drawing start register to the drawing end register. In this way, the process at Step S6 is completed, and the image processing proceeds to a process at Step S7.

In the process at Step S7, the synthesizing unit 5336 synthesizes the drawing layer and an image layer generated from image data to be described later, and the display control unit 5337 displays the synthesized display image on the display unit 536. If an image layer has not been generated, a display image of only the drawing layer is output to the display unit 536. In this way, the process at Step S7 is completed, and the image processing returns to Step S1 to wait to receive image data or another event.

Image-Data Receiving Process

Subsequently, an image-data receiving process (Steps S11 to S13 and S6 to S7) performed when the communication control unit 535 has received image data from the image processing server 502 is explained. Through this image-data receiving process, a display image formed by synthesizing the received image data and the latest draw data is displayed on the display unit 536.

In the process at Step S11, the drawing-limits determining unit 5332 refers to identification information of an image processing apparatus 503 and identification information of drawing data which are included in the image data received from the image processing server 502. When its own identification information of the image processing apparatus 503 is included, the drawing-limits determining unit 5332 compares the identification information of the drawing data with a value of the drawing start register, and determines whether the identification information of the drawing data is the one issued later than the value of the drawing start register. When the identification information of the drawing data is the one issued later than the value of the drawing start register (YES at Step S11), the image processing proceeds to a process at Step S12. On the other hand, when the identification information of the drawing data is the one issued before the value of the drawing start register (NO at Step S11), the image processing proceeds to a process at Step S13. Incidentally, if the received image data does not include identification information of drawing data, or if no value has been set in the drawing start register, the image processing proceeds to the process at Step S13.

In the process at Step S12, the drawing-limits determining unit 5332 updates a value of the drawing start register with the identification information of the drawing data included in the image data received from the image processing server 502. In addition, the drawing-limits determining unit 5332 deletes older drawing data than the drawing data corresponding to the updated drawing start register from the RAM 533.

Incidentally, in the process at Step S11, if the identification information of the drawing data included in the image data received from the image processing server 502 is newer than the value of the drawing start register, that means part or all of the drawing data input to the image processing apparatus 503 is included in the image data. Therefore, the value of the drawing start register is updated so that out of the drawing data input to the image processing apparatus 503, drawing data newer than the drawing data included in the image data is output to the display unit 536. At this time, for the sake of security, the value of the drawing start register can be updated with identification information of drawing data older than the identification information of the drawing data included in the received image data. In this way, the process at Step S12 is completed, and the image processing proceeds to the process at Step S13.

On the other hand, in the process at Step S11, if the identification information of the drawing data included in the image data received from the image processing server 502 is the one issued before the value of the drawing start register, that means the drawing data input to the image processing apparatus 503 is not included in the received image data. Therefore, the process at Step S12 is skipped so that already-input drawing data is output to the display unit 536 together with the image data received from the image processing server 502.

In the process at Step S13, the app-image generating unit 5335 generates an image layer of a display image from the image data received from the image processing server 502. For example, if the image data has been compressed, the app-image generating unit 5335 decompresses the image data to an image layer. In this way, the process at Step S13 is completed, and the image processing proceeds to the process at Step S6.

In the process at Step S6, as described above, the drawing-data generating unit 5333 generates a drawing layer of a display image from drawing data on the RAM 533 corresponding to from the drawing start register to the drawing end register. In this way, the process at Step S6 is completed, and the image processing proceeds to the process at Step S7. Incidentally, if no value has been set in the drawing start register, the process at Step S6 is skipped.

In the process at Step S7, as described above, a display image formed by synthesizing the image layer and a drawing layer generated from the drawing data with the synthesizing unit 5336 is output to the display unit 536 through control by the display control unit 5337. If a drawing layer has not been generated, a display image of only the image layer is output to the display unit 536. In this way, the process at Step S7 is completed, and the image processing returns to Step S1 to wait to receive the latest image data or event.

As explained above, according to the image processing system, image processing method, and image processing program in the present embodiment, the image processing apparatus 503 displays thereon only the minimum drawing data until image processing by the image processing server 502 has been completed. Therefore, the image processing apparatus 503 is not required to have a high software processing capacity, and can display thereon drawing data without delay. Furthermore, when image processing by the image processing server 502 has been completed, drawing data input before then is deleted from the RAM 33 (the memory) of the image processing apparatus 503; therefore, it is possible to reduce the memory capacity required of the image processing apparatus 503. Consequently, it is possible to reduce the software processing capacity and memory capacity required of the image processing apparatus 503, thereby achieving the image processing apparatus 503 capable of displaying thereon a drawn image handwritten by a user without delay at low cost. Furthermore, according to the image processing system 501 including two or more image processing apparatuses 503, the image processing apparatuses 503 are placed in respective multiple bases of a remote meeting; therefore, it is possible to easily achieve a remote meeting in which a drawn image handwritten by a user can be displayed without delay at low cost.

### Second Embodiment

Subsequently, a distribution management apparatus according to a second embodiment of the present invention is explained in detail below with reference to accompanying drawings. Incidentally, the present invention is not limited to this embodiment. Furthermore, the identical components are denoted by the same reference numeral in the drawings.

A distribution system according to the present embodiment is explained in detail below with drawings. In the embodiment described below, the present invention is applied to a distribution system that uses cloud computing to convert Web content into video data, sound data, or video data and sound data and distribute the converted data to communication terminals such as a PC and an electronic blackboard. Incidentally, hereinafter, when at least one of video and sound is described, it is referred to as “video (sound)”.

### Outline of Embodiment

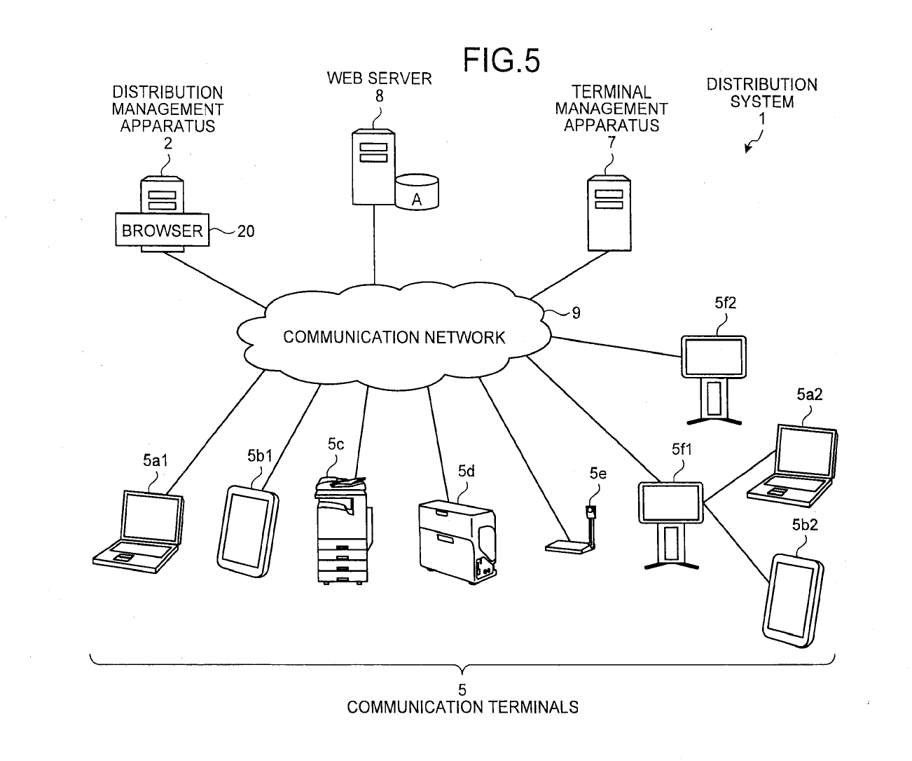

First, an outline of the present embodiment is explained with FIG. 5. FIG. 5 is a schematic diagram of a distribution system 1 according to the present embodiment.

Outline of System Configuration

First, an outline of a configuration of the distribution system 1 is explained.

As shown in FIG. 5, the distribution system 1 according to the present embodiment includes a distribution management apparatus 2, multiple communication terminals 5a1, 5a2, 5b1, 5b2, 5c to 5e, 5f1, and 5f2, a terminal management apparatus 7, and a Web server 8. Incidentally, hereinafter, when any of the communication terminals 5a1, 5a2, 5b1, 5b2, 5c to 5e, 5f1, and 5f2 is described, it is referred to as “communication terminal(s) 5”. The distribution management apparatus 2, the terminal management apparatus 7, and the Web server 8 are each built up with a server computer.

The communication terminals 5 are terminals used by users who get the service of the distribution system 1. Out of the communication terminals 5, the communication terminals 5a1 and 5a2 are notebook PCs. The communication terminals 5b1 and 5b2 are mobile terminals, such as a smartphone and a tablet terminal. The communication terminal 5c is a multifunction peripheral/printer/product (MFP) having multiple functions of copy, scan, print, and fax. The communication terminal 5d is a projector. The communication terminal 5e is a video-conference terminal equipped with a camera, a microphone, and a speaker. The communication terminals 5f1 and 5f2 are electronic blackboards (whiteboards) capable of electronically converting user-drawn content.

Incidentally, the communication terminals 5 are not limited to those shown in FIG. 5, and include a wristwatch, a vending machine, a gas meter, a car navigation system, a game machine, an air-conditioner, lighting equipment, a camera alone, a microphone alone, and a speaker alone.

The distribution management apparatus 2, the communication terminals 5, the terminal management apparatus 7, and the Web server 8 can communicate with one another over a communication network 9 such as the Internet and a local area network (LAN). The communication network 9 includes wireless communication networks, such as 3G (3rd Generation), WiMAX (Worldwide Interoperability for Microwave Access), and LTE (Long Term Evolution).

Incidentally, like the communication terminal 5d or the like, some of the communication terminals 5 have no function of communicating with other terminals and systems over the communication network 9. However, as shown in FIG. 2, by a user inserting a dongle into a USB (Universal Serial Bus) interface or HDMI® (High-Definition Multimedia Interface) part of the communication terminal 5d, the communication terminal 5 become able to communicate with other terminals and systems over the communication network 9.

The distribution management apparatus 2 has a so-called cloud browser (hereinafter, referred to as “browser 20”) as a Web browser existing on a cloud. The distribution management apparatus 2 renders Web content on the cloud by using the browser 20, and distributes obtained H.264 or MPEG-4 video (sound) data to a communication terminal 5.

The terminal management apparatus 7 has a function as a management server, and performs, for example, login authentication of a communication terminal 5 and management of contract information of the communication terminals 5 or the like. Furthermore, the terminal management apparatus 7 has a function of an SMTP (Simple Mail Transfer Protocol) server for sending an e-mail. The terminal management apparatus 7 can be realized, for example, as a virtual machine developed on IaaS (Infrastructure as a Service) which is a service of the cloud. The terminal management apparatus 7 is preferably multiplexed to perform continuous service provision while coping with contingencies.

Incidentally, the browser 20 of the distribution management apparatus 2 enables real-time communication/collaboration (RTC). Furthermore, an encoder bridge unit 30 (an encoding unit 19 shown in FIG. 20) included in the distribution management apparatus 2 can perform real-time encoding of video (sound) data generated by the browser 20. Therefore, processing by the distribution management apparatus 2 is different from, for example, a case where non-real-time video (sound) data recorded on a DVD is read by a DVD player and is distributed.

Outlines of Various Distribution Methods

Subsequently, outlines of various distribution methods are explained.

Basic Distribution

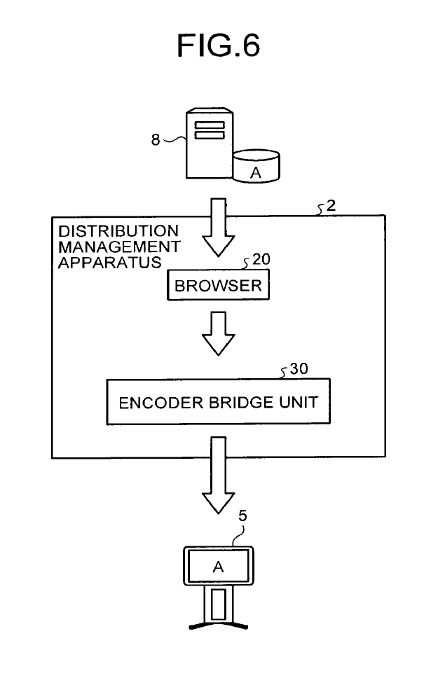

FIG. 6 is a conceptual diagram showing a basic distribution method of the distribution system 1 according to the present embodiment. In the distribution system 1, as shown in FIG. 6, the browser 20 of the distribution management apparatus 2 acquires Web content data [A] from the Web server 8, and generates video (sound) data [A] by rendering the acquired Web content data [A]. Then, the encoder bridge unit 30 encodes the video (sound) data [A], and the encoded video (sound) data [A] is distributed to a communication terminal 5. Accordingly, even if Web content created in HTML (Hypertext Markup Language), CSS (Cascading Style Sheets) or the like is rich, the Web content is distributed as H.264 or MPEG-4 video (sound) data; therefore, even a low-spec communication terminal 5 can reproduce the video (sound) smoothly. Furthermore, in the distribution system 1 according to the present embodiment, the browser 20 of the distribution management apparatus 2 is updated to the latest version; therefore, rich up-to-date Web content can be smoothly reproduced without updating a browser that provides content in a local communication terminal 5.

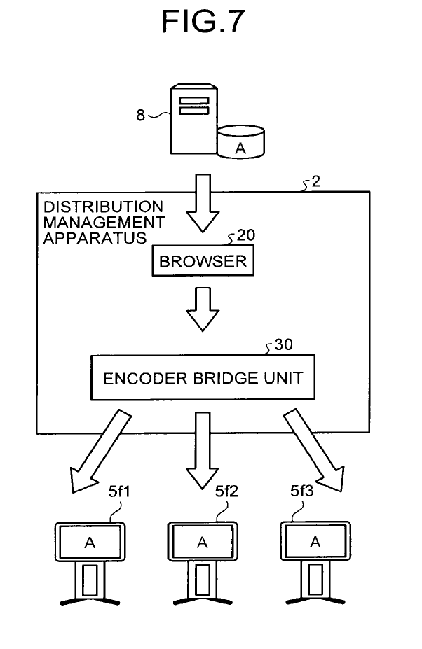

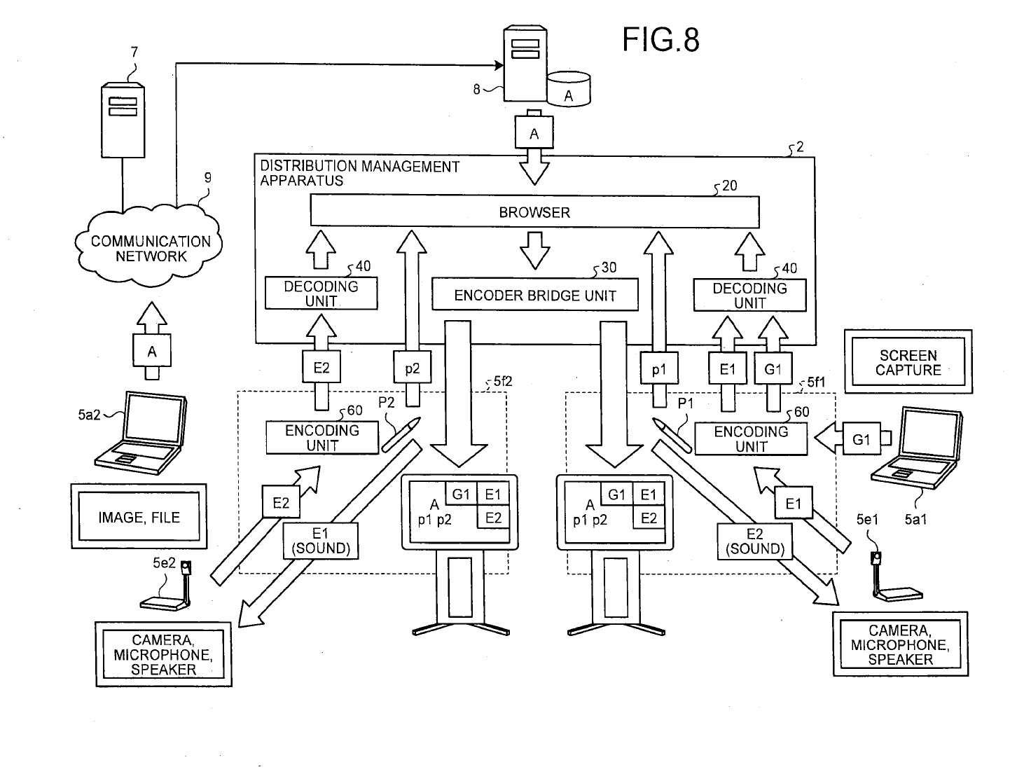

Furthermore, as shown in FIGS. 7 and 8, by applying the above-described distribution method, the distribution system 1 can distribute Web content in the form of video (sound) data to multiple communication terminals 5 in the same base or different bases. Distribution methods shown in FIGS. 7 and 8 are explained below.

### Multicast

FIG. 7 is a conceptual diagram of multicast. As shown in FIG. 7, the single browser 20 of the distribution management apparatus 2 acquires Web content data [A] from the Web server 8, and generates video (sound) data [A] by rendering the acquired Web content data [A]. Then, the encoder bridge unit 30 encodes the video (sound) data [A]. After that, the distribution management apparatus 2 distributes the video (sound) data [A] to multiple communication terminals 5f1, 5f2, and 5f3. Accordingly, the same video (sound) is output to the multiple communication terminals 5f1, 5f2, and 5f3 placed, for example, in multiple different bases. Incidentally, in this case, the multiple communication terminals 5f1, 5f2, and 5f3 do not have to have the same display reproduction capability (the same resolution or the like). Such a distribution method is called, for example, “multicast”.

Composite Distribution

FIG. 8 is a conceptual diagram of a remote sharing process using the distribution management apparatus 2. As shown in FIG. 8, in a first base (the right side in FIG. 8), a communication terminal 5f1 as an electronic blackboard and a communication terminal 5e1 as a video-conference terminal are used; in a second base (the left side in FIG. 8), a communication terminal 5f2 as an electronic blackboard and a communication terminal 5e2 as a video-conference terminal are used. Furthermore, in the first base, an electronic pen P1 for displaying operation data, such as a character drawn by a stroke of the electronic pen P1, on the communication terminal 5f1 is used; in the second base, an electronic pen P2 for displaying operation data, such as a character drawn by a stroke of the electronic pen P2, on the communication terminal 5f2 is used. Incidentally, in the example shown in FIG. 8, in the first base, the communication terminal 5e1 as a video-conference terminal is connected to the communication terminal 5f1 as an electronic blackboard, and a camera, microphone, and speaker of the communication terminal 5e1 are used as an external camera, microphone, and speaker of the communication terminal 5f1. Likewise, in the second base, the communication terminal 5e2 as a video-conference terminal is connected to the communication terminal 5f2 as an electronic blackboard, and a camera, microphone, and speaker of the communication terminal 5e2 are used as an external camera, microphone, and speaker of the communication terminal 5f2.

Furthermore, in the first base, a capture G1 of a screen displayed on a communication terminal 5a1 is used, so the communication terminals 5a1 and 5f1 are connected by wired or wireless. When the connection method is wired connection, the screen capture G1 is transmitted to a capture device of the communication terminal 5f1 via an image transmission cable (VGA, HDMI®, DisplayPort, DVI-I/D, or the like), and the capture device transmits the screen capture G1 to an encoding unit 60 through an internal I/F (PCI-E USB, or the like).

When the connection method is wireless connection, the screen capture G1 is transmitted to an input device of the communication terminal 5f1 by using a wireless display transmitting technique, and the input device transmits the screen capture G1 to the encoding unit 60 through the internal I/F. The wireless display transmitting technique includes, for example, Wi-Fi® Alliance Miracast and Intel® Wireless Display.

Incidentally, the communication terminal 5f1 can receive screen captures G1 from multiple communication terminals 5a. In this case, the communication terminal 5f1 displays multiple thumbnail images of the screen captures G1 on the screen of the communication terminal 5f1 so that a capture G1 of a screen of a communication terminal 5a corresponding to a thumbnail image selected by a user can be used.

In the second base, content A of a communication terminal 5a2 for which login has been authenticated by the terminal management apparatus 7 is used. The communication terminal 5a2 uploads the content A onto the Web server 8 via the communication network 9. The Web server 8 stores therein the content A of the communication terminal 5a2 as Web content data.

In the first base, video (sound) data [E1] acquired by the communication terminal 5e1 is encoded by the encoding unit 60, and then is transmitted to the distribution management apparatus 2. After that, the video (sound) data [E1] is decoded by a decoding unit 40 of the distribution management apparatus 2, and is input to the browser 20. Furthermore, operation data [p1] indicating a stroke drawn on the communication terminal 5f1 with the electronic pen P1 or the like is transmitted to the distribution management apparatus 2, and is input to the browser 20. Moreover, the screen capture [G1] of the communication terminal 5a1 is encoded by the encoding unit 60, and then is transmitted to the distribution management apparatus 2. After that, the screen capture [G1] is decoded by the decoding unit 40 of the distribution management apparatus 2, and is input to the browser 20. On the other hand, in the second base, video (sound) data [E2] acquired by the communication terminal 5e2 is encoded by the encoding unit 60, and then is transmitted to the distribution management apparatus 2. After that, the video (sound) data [E2] is decoded by the decoding unit 40 of the distribution management apparatus 2, and is input to the browser 20. Furthermore, operation data [p2] indicating a stroke drawn on the communication terminal 5f2 with the electronic pen P2 or the like is transmitted to the distribution management apparatus 2, and is input to the browser 20.

Meanwhile, the browser 20 acquires, for example, Web content data [A] of a background image displayed on respective displays of the communication terminals 5f1 and 5f2 from the Web server 8. Then, the browser 20 combines the Web content data [A], the screen capture data [G1], the operation data [p1] and [p2], and the video (sound) data [E1] and [E2] and performs rendering, thereby generating video (sound) data in which the above data are arranged in a desired layout. Then, the encoder bridge unit 30 encodes the video (sound) data, and the distribution management apparatus 2 distributes the same video (sound) data to the bases. Accordingly, in the first base, video ([A], [G1], [p1], [p2], [E1 (video part)], and [E2 (video part)]) is displayed on the display of the communication terminal 5f1, and sound [E2 (sound part)] is output from the speaker of the communication terminal 5e1. On the other hand, in the second base, the video ([A], [G1], [p1], [p2], [E1 (video part)], and [E2 (video part)]) is displayed on the display of the communication terminal 5f2, and sound [E1 (sound part)] is output from the speaker of the communication terminal 5e2. Incidentally, in the first base, the sound [E1 (sound part)] in the first base is not output by an echo cancellation function of the communication terminal 5f1. On the other hand, in the second base, the sound [E2 (sound part)] in the second base is not output by an echo cancellation function of the communication terminal 5f2.

In this way, it is possible to perform the remote sharing process for sharing the same information between remote locations of the first and second bases in real time; therefore, the distribution system 1 according to the present embodiment is useful in a remote meeting and the like.

### DETAILED DESCRIPTION OF EMBODIMENT

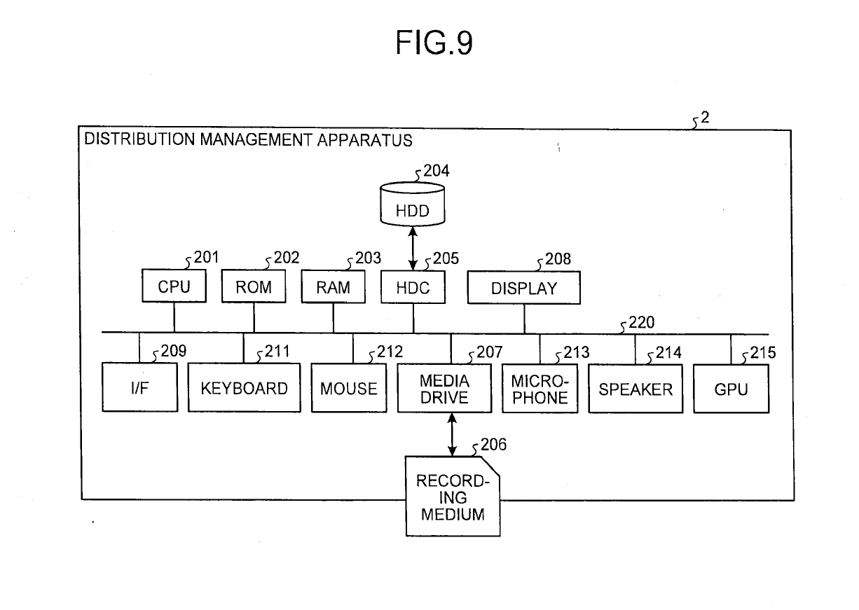

Subsequently, the embodiment is explained in detail with FIGS. 9 to 27.

### Hardware Configuration of Embodiment

First, a hardware configuration of the present embodiment is explained with FIG. 9. FIG. 9 is a diagram showing an example of a hardware configuration of the distribution management apparatus 2. Incidentally, the communication terminals 5, the terminal management apparatus 7, and the Web server 8 have the same hardware configuration as the distribution management apparatus 2, so description is omitted.

As shown in FIG. 9, the distribution management apparatus 2 includes a CPU 201 that controls the operation of the entire distribution management apparatus 2, a ROM 202 that stores therein a program such as an IPL used to drive the CPU 201, a RAM 203 used as a work area of the CPU 201, an HDD 204 that stores therein various data such as a program, a hard disk controller (HDC) 205 that controls the reading/writing of data from/on the HDD 204 in accordance with control by the CPU 201, a media drive 207 that controls the reading/writing of data from/on a recording medium 206 such as a flash memory, a display 208 that displays thereon information, an I/F 209 for data transmission using the communication network 9, a keyboard 211, a mouse 212, a microphone 213, a speaker 214, a graphics processing unit (GPU) 215, and a bus line 220 such as an address bus and a data bus for electrically connecting the above components.

Incidentally, respective programs for each communication terminal, each system, and each server can be distributed in such a manner that each program is recorded on a computer-readable recording medium, such as the recording medium 206, in an installable or executable file format.

### Functional Configuration of Embodiment

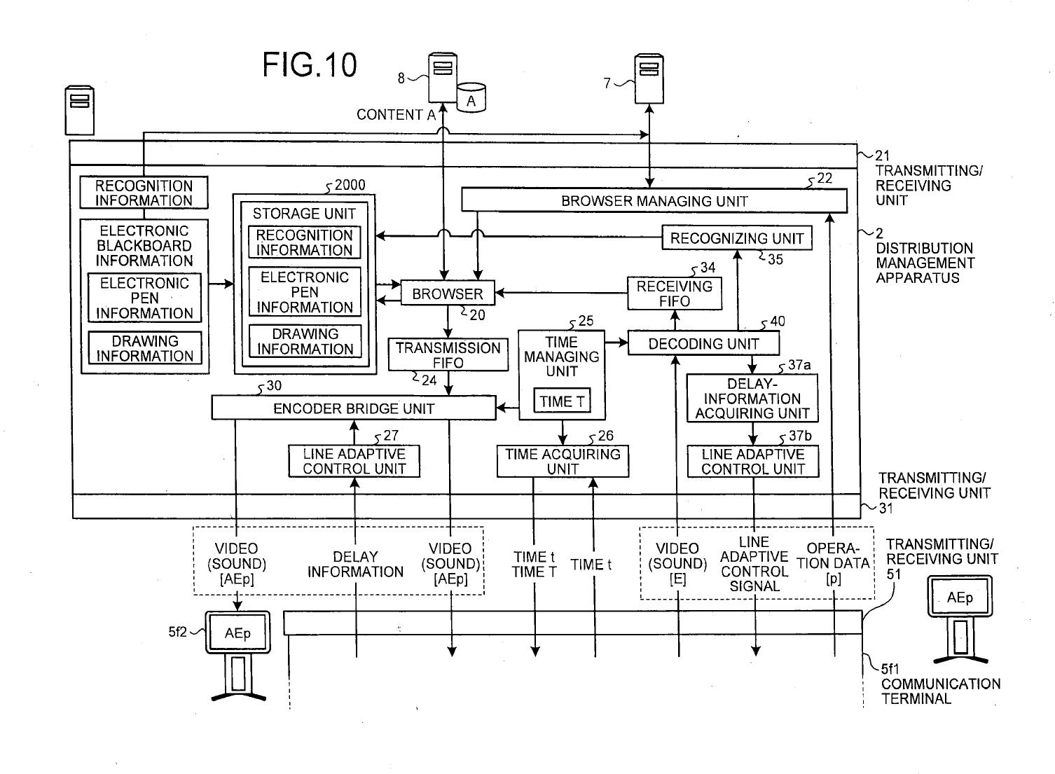

Subsequently, a functional configuration of the present embodiment is explained with FIGS. 10 to 20. FIG. 10 is a functional block diagram showing mainly functions of the distribution management apparatus 2. FIG. 10 shows the functional configuration in the case where the distribution management apparatus 2 distributes video (sound) data to the communication terminal 5f1; however, in the case where a distribution destination is other communication terminals other than the communication terminal 5f1, the distribution management apparatus 2 has the similar functional configuration. Incidentally, the distribution management apparatus 2 includes a plurality of distribution engine servers; however, for sake of simplicity, the case where the distribution management apparatus 2 includes a single distribution engine server is explained below.

Functional Configuration of Distribution Management Apparatus

The distribution management apparatus 2 realizes the functional configuration shown in FIG. 10 by means of the hardware configuration shown in FIG. 9 and a program. Specifically, the distribution management apparatus 2 includes the browser 20, a transmitting/receiving unit 21, a browser managing unit 22, a transmission FIFO 24, a time managing unit 25, a time acquiring unit 26, a line adaptive control unit 27, the encoder bridge unit 30, a transmitting/receiving unit 31, a receiving FIFO 34, a recognizing unit 35, a delay-information acquiring unit 37a, a line adaptive control unit 37b, and the decoding unit 40. Furthermore, the distribution management apparatus 2 includes a storage unit 2000 built up with the HDD 204 shown in FIG. 8. In this storage unit 2000, recognition information output from the recognizing unit 35 and electronic blackboard information (electronic pen information and drawing information) are stored. Incidentally, content data acquired by the browser 20 can be temporarily stored in the storage unit 2000 as a cache.

Out of the above functional components, the browser 20 is a Web browser that operates in the distribution management apparatus 2. The browser 20 renders content data such as Web content data, thereby generating video (sound) data as RGB data (or pulse-code modulation (PCM) data). The browser 20 is constantly updated to the latest version so as to cope with the tendency that the Web content is made richer.

Furthermore, in the distribution system 1 according to the present embodiment, a plurality of browsers 20 is prepared in the distribution management apparatus 2, and a cloud browser used in a user session is selected from among these browsers 20. Incidentally, here, for sake of simplicity, the case where a single browser 20 is prepared in the distribution management apparatus 2 is explained below.

The browser 20 has, for example, Media Player, Flash Player, JavaScript®, CSS (Cascading Style Sheet), and HTML (HyperText Markup Language) renderer. Incidentally, the JavaScript® includes standard one and unique one to the distribution system 1. The Media Player here is browser plug-in for reproducing a multimedia file, such as a video (sound) file, in the browser 20. The Flash Player is browser plug-in for reproducing Flash content in the browser 20. The unique JavaScript® is a JavaScript® group that provides an application programming interface (API) for a service specific to the distribution system 1. The CSS is a technique for efficiently defining the appearance and style of a Web page written in HTML. The HTML renderer is a WebKit-based HTML rendering engine. Furthermore, the browser 20 receives operation data [p] from the browser managing unit 22, and generates drawing information or electronic pen information (drawing setting information) from the operation data [p]. The browser 20 stores the generated drawing information or electronic pen information in the storage unit 2000. Drawing information and electronic pen information are described later.

The transmitting/receiving unit 21 transmits/receives various data, requests, and/or the like to/from the terminal management apparatus 7 and the Web server 8. For example, the transmitting/receiving unit 21 acquires Web content data from a content site of the Web server 8. Furthermore, the transmitting/receiving unit 21 transmits/receives recognition information and electronic blackboard information (drawing information and electronic pen information) to/from the terminal management apparatus 7.

The browser managing unit 22 manages the browser 20 and the encoder bridge unit 30. For example, the browser managing unit 22 instructs the browser 20 and the encoder bridge unit 30 to start or end, and assigns an encoder ID at the start or end. The encoder ID here is identification information assigned in order for the browser managing unit 22 to manage the process of the encoder bridge unit 30. Furthermore, each time the browser 20 is started, the browser managing unit 22 assigns and manages a browser ID. The browser ID here is identification information assigned by the browser managing unit 22 to manage the process of the browser 20 and to identify the browser 20.

Furthermore, the browser managing unit 22 acquires operation data [p] from a communication terminal 5 through the transmitting/receiving unit 21, and outputs the acquired operation data [p] to the browser 20. Incidentally, the operation data [p] is data generated by an operation event (an operation with the keyboard 211 or the mouse 212, a stroke of the electronic pen P1, or the like) in the communication terminal 5. When the communication terminal 5 is provided with sensors such as a temperature sensor, a humidity sensor, and an acceleration sensor, the browser managing unit 22 acquires sensor information, which corresponds to output signals of the sensors, from the communication terminal 5, and outputs the acquired sensor information to the browser 20.

The transmission FIFO 24 is a buffer that stores therein video (sound) data [AEp] generated by the browser 20.

The time managing unit 25 manages the time T unique to the distribution management apparatus 2. The time acquiring unit 26 performs a time adjusting process in cooperation with a time control unit 56 of a communication terminal 5. Specifically, the time acquiring unit 26 acquires time information (T) indicating the time T in the distribution management apparatus 2 from the time managing unit 25, and receives time information (t) indicating the time t in the communication terminal 5 from the time control unit 56, and transmits the time information (t) and the time information (T) to the time control unit 56.

The line adaptive control unit 27 calculates a reproduction delay time U on the basis of transmission delay time information (D), and calculates operating conditions, such as a frame rate and data resolution, of a converting unit 10 of the encoder bridge unit 30. This reproduction delay time is a time to delay reproduction to buffer data before the reproduction.

The encoder bridge unit 30 outputs video (sound) data [AEp] that has been generated by the browser 20 and stored in the transmission FIFO 24 to the converting unit 10 of the encoder bridge unit 30. The encoder bridge unit 30 is explained in detail below with FIGS. 19 and 20. FIG. 19 is a detail view of the encoder bridge unit 30. FIG. 20 is a functional block diagram showing functions of the converting unit 10.

As shown in FIG. 19, the encoder bridge unit 30 includes a generating/selecting unit 310, a selecting unit 320, and a plurality of converting units 10a, 10b, and 10c built between the generating/selecting unit 310 and the selecting unit 320. Here, the encoder bridge unit 30 includes three converting units 10a, 10b, and 10c; however, the encoder bridge unit 30 can include any number of the converting units 10. Incidentally, hereinafter, any converting unit is referred to as the “converting unit 10”.

As shown in FIG. 20, the converting unit 10 includes a trimming unit 11, a resizing unit 12, and the encoding unit 19. In the case of sound data, the trimming unit 11 and the resizing unit 12 do not perform processing.

The trimming unit 11 performs a process of capturing only a part of video (an image). The resizing unit 12 rescales video (an age).

The encoding unit 19 encodes video (sound) data generated by the browser 20, thereby converting the video (sound) data into data that can be distributed to a communication terminal 5 via the communication network 9. Furthermore, if there is no motion in video (if there is no change between frames), the encoding unit 19 inserts skip frames until there is a motion in the video to save the bandwidth. Incidentally, in the case of sound, the encoding unit 19 performs only the encoding.

The generating/selecting unit 310 newly creates a converting unit 10, and selects video (sound) data to be input to an already-created converting unit 10. Cases where the generating/selecting unit 310 newly creates a converting unit 10 include, for example, when it is necessary to create a converting unit 10 capable of conversion according to reproduction capability of a communication terminal 5 to reproduce video (sound) data. Furthermore, when the generating/selecting unit 310 selects video (sound) data to be input to a converting unit 10, the generating/selecting unit 310 selects an already-created converting unit 10. For example, in starting data distribution to the communication terminal 5b in addition to data distribution to the communication terminal 5a, the same video (sound) data as that distributed to the communication terminal 5a may be distributed to the communication terminal 5b. In such a case, furthermore, the communication terminal 5b may have the same video (sound) data reproduction capability as the communication terminal 5a. That is, in such a case, the generating/selecting unit 310 uses an already-created converting unit 10a for the communication terminal 5a without creating a new converting unit 10b for the communication terminal 5b.

The selecting unit 320 selects a desired one from among already-created converting units 10. Through the selection by the generating/selecting unit 310 and the selecting unit 320, various patterns of distribution as shown in FIG. 8 can be performed.

Returning to FIG. 10, the transmitting/receiving unit 31 transmits/receives various data, requests, and/or the like to/from communication terminals 5. For example, in a login process of a communication terminal 5, the transmitting/receiving unit 31 transmits authentication screen data for prompting a user to log in to a transmitting/receiving unit 51 of the communication terminal 5. In addition, the transmitting/receiving unit 31 performs data transmission and receiving to/from an application program (a user app or a device app) installed on the communication terminal 5 to receive the service of the distribution system 1 through an HTTPS (HyperText Transfer Protocol over Secure Socket Layer) server according to a protocol unique to the distribution system 1. This unique protocol is an HTTPS-based application layer protocol for transmitting/receiving data in real time to/from the communication terminal 5 of the distribution management apparatus 2 without any interruption. Furthermore, the transmitting/receiving unit 31 performs processes of transmission response control, real-time data creation, command transmission, receiving response control, received-data analysis, and gesture conversion.

The transmission response control is a process of managing an HTTPS session for download requested by a communication terminal 5 to transmit data from the distribution management apparatus 2 to the communication terminal 5. A response to this HTTPS session for download is not terminated immediately, and is held for a given length of time (one to a few minutes). The transmitting/receiving unit 31 dynamically writes data to be transmitted to the communication terminal 5 in the body part of the response. Furthermore, to eliminate the cost for reconnection, the transmitting/receiving unit 31 is configured to receive another request from the communication terminal 5 before the previous session ends. The transmitting/receiving unit 31 waits until completion of the previous request; therefore, overhead can be eliminated even a reconnection is established.

The real-time data creation is a process of adding the original header to data (RTP data) of a compressed video (and a compressed sound) generated by the encoding unit 19 shown in FIG. 20 and writing the data in the body part of a downlink HTTPS.

The command transmission is a process of generating command data to be transmitted to a communication terminal 5 and writing the command data in the body part of a downlink HTTPS for distribution to the communication terminal 5.

The receiving response control is a process of managing an HTTPS session for transmission (uplink) requested by a communication terminal 5 in order for the distribution management apparatus 2 to receive data from the communication terminal 5. A response to this HTTPS session is not terminated immediately, and is held for a given length of time (one to a few minutes). The communication terminal 5 dynamically writes data to be transmitted to the transmitting/receiving unit 31 of the distribution management apparatus 2 in the body part of the request.

The received-data analysis is a process of analyzing data transmitted from a communication terminal 5 with respect to each type of the data and passing the data to a required process.

The gesture conversion is a process of converting a gesture event input on a communication terminal 5f as an electronic blackboard by a user with an electronic pen P or by hand into a form that the browser 20 can receive.

The receiving FIFO 34 is a buffer that stores therein video (sound) data decoded by the decoding unit 40.

The recognizing unit 35 performs processing on video (sound) data [E] received from a communication terminal 5. Specifically, for example, for signage, the recognizing unit 35 recognizes the face, age, and sex of a person or an animal from video taken by a camera 62. Furthermore, for an office, the recognizing unit 35 performs name tagging through facial recognition from video taken by the camera 62, replacement of a background image, and/or the like. The recognizing unit 35 stores recognition information on recognized content in the storage unit 2000. This recognizing unit 35 performs processing with a recognition expansion board to achieve high-speed processing.

The delay-information acquiring unit 37a is used in a downlink line adaptive control process in correspondence to a delay-information acquiring unit 57 used in an uplink line adaptive control process. Specifically, the delay-information acquiring unit 37a acquires transmission delay time information (d1) indicating a transmission delay time d1 from the decoding unit 40 and holds the acquired transmission delay time information (d1) for a given length of time, and when having acquired multiple pieces of transmission delay time information (d1), the delay-information acquiring unit 37a outputs transmission delay time information (d) indicating frequency distribution information based on the multiple pieces of transmission delay time information d1 to the line adaptive control unit 37b.

The line adaptive control unit 37b is used in a downlink line adaptive control process in correspondence to the above-described line adaptive control unit 27 used in an uplink line adaptive control process. Specifically, the line adaptive control unit 37b calculates operating conditions of the encoding unit 60 on the basis of the transmission delay time information (d). Furthermore, the line adaptive control unit 37b transmits a line adaptive control signal indicating the operating conditions, such as a frame rate and data resolution, to the encoding unit 60 of a communication terminal 5 through the transmitting/receiving unit 31 and the transmitting/receiving unit 51.

The decoding unit 40 decodes video (sound) data [E] transmitted from a communication terminal 5.

Functional Configuration of Communication Terminal

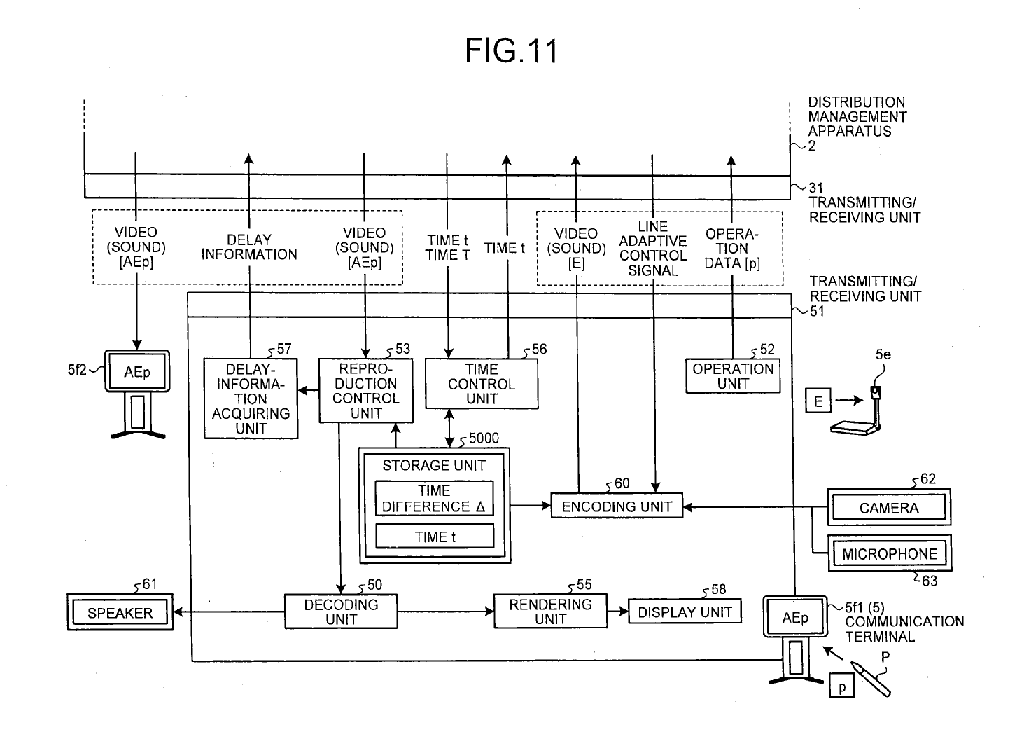

Subsequently, a functional configuration of the communication terminal 5 is explained with FIG. 11. FIG. 11 is a functional block diagram showing mainly functions of the communication terminal 5. FIG. 11 illustrates a functional configuration of the communication terminal 5f1 as one of the communication terminals 5; however, the communication terminals 5 other than the communication terminal 5f1 have the similar functional configuration. Incidentally, out of the communication terminals 5, a communication terminal 5 installed with a user app functions as an interface for a user to log in to the distribution system 1 and to start and stop distribution of video (sound) data. On the other hand, a communication terminal 5 installed with a device app performs only transmission and receiving of video (sound) data and transmission of operation data, and does not have the function of such an interface. For the sake of convenience, assume that the communication terminal 5 is installed with a user app.

The communication terminal 5 realizes the functional configuration shown in FIG. 11 by means of the same hardware configuration as that shown in FIG. 8 and a program (a user app). Specifically, the communication terminal 5 includes a decoding unit 50, the transmitting/receiving unit 51, an operation unit 52, a reproduction control unit 53, a rendering unit 55, the time control unit 56, the delay-information acquiring unit 57, display unit 58, and the encoding unit 60. Furthermore, the communication terminal 5 includes a storage unit 5000 built up with the RAM 203. In this storage unit 5000, time difference information (Δ) indicating a time difference Δ and time information (t) indicating the time t in the communication terminal 5 are stored.

The decoding unit 50 decodes video (sound) data [AEp] that has been distributed from the distribution management apparatus 2 and output from the reproduction control unit 53.

The transmitting/receiving unit 51 transmits/receives various data, requests, and/or the like to/from the transmitting/receiving unit 31 of the distribution management apparatus 2 and a transmitting/receiving unit 71a of the terminal management apparatus 7. For example, in a login process of the communication terminal 5, the transmitting/receiving unit 51 transmits a request for login to the transmitting/receiving unit 71a of the terminal management apparatus 7 on the basis of start-up of the communication terminal 5 through the operation unit 52.

The operation unit 52 receives user operation input. For example, the operation unit 52 receives input or selection made through a power switch, a keyboard, a mouse, an electronic pen P, or the like, and transmits the received input or selection as operation data [p] to the browser managing unit 22 of the distribution management apparatus 2.

The reproduction control unit 53 buffers video (sound) data [AEp] (a packet of real-time data) received from the transmitting/receiving unit 51, and outputs the video (sound) data [AEp] to the decoding unit 50 in consideration of a reproduction delay time U.

The rendering unit 55 renders data decoded by the decoding unit 50.

The time control unit 56 performs a time adjusting process in cooperation with the time acquiring unit 26 of the distribution management apparatus 2. Specifically, the time control unit 56 acquires the time information (t) indicating the time t in the communication terminal 5 from the storage unit 5000. Furthermore, the time control unit 56 requests the time acquiring unit 26 of the distribution management apparatus 2 to transmit time information (T) indicating the time T in the distribution management apparatus 2 through the transmitting/receiving unit 51 and the transmitting/receiving unit 31. In this case, the time information (t) is transmitted together with the request for time information (T).

The delay-information acquiring unit 57 acquires transmission delay time information (D1) indicating a transmission delay time D1 from the reproduction control unit 53 and holds the acquired transmission delay time information (D1) for a given length of time, and when having acquired multiple pieces of transmission delay time information (D1), the delay-information acquiring unit 57 transmits transmission delay time information (D) indicating frequency distribution information based on the multiple transmission delay times D1 to the line adaptive control unit 27 through the transmitting/receiving unit 51 and the transmitting/receiving unit 31. Incidentally, the transmission delay time information (D) is transmitted, for example, once every 100 frames.

The display unit 58 reproduces data rendered by the rendering unit 55.

The encoding unit 60 transmits encoded video (sound) data of video (sound) data [E] acquired from the internal microphone 213 (see FIG. 9) or the external camera 62 and microphone 63, time information (t0) indicating the current time t0 in the communication terminal 5 acquired from the storage unit 5000, and time difference information (Δ) indicating a time difference Δ acquired from the storage unit 5000 to the decoding unit 40 of the distribution management apparatus 2 through the transmitting/receiving unit 51 and the transmitting/receiving unit 31. The operating conditions of the encoding unit 60 are changed on the basis of a line adaptive control signal received from the line adaptive control unit 37b. If the operating conditions are changed, the encoding unit 60 transmits encoded video (sound) data of video (sound) data [E] acquired from the camera 62 and microphone 63, time information (t0) indicating the current time t0 in the communication terminal 5 acquired from the storage unit 5000, and time difference information (Δ) indicating a time difference Δ acquired from the storage unit 5000 to the decoding unit 40 of the distribution management apparatus 2 through the transmitting/receiving unit 51 and the transmitting/receiving unit 31 in accordance with new operating conditions.

Incidentally, the internal microphone 213 and the external camera 62 and microphone 63 are examples of an input means, and are devices that require encoding or decoding. The input means can output touch data and smell data besides video (sound) data. The input means include sensors such as a temperature sensor, a direction sensor, and an acceleration sensor. FIG. 11 shows an example where the communication terminal 5e as a video-conference terminal is connected to the communication terminal 5f1 as an electronic blackboard, and the camera and microphone of the communication terminal 5e are used as the external camera 62 and microphone 63 of the communication terminal 5f1.

Functional Configuration of Terminal Management Apparatus

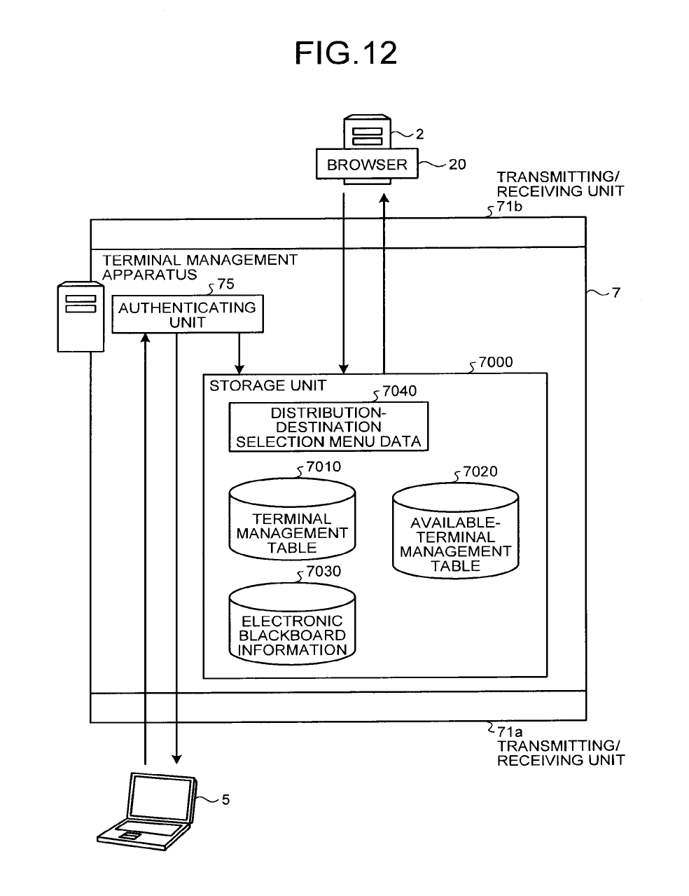

Subsequently, a functional configuration of the terminal management apparatus 7 is explained with FIG. 12. FIG. 12 is a functional block diagram showing functions of the terminal management apparatus 7.

The terminal management apparatus 7 realizes the functional configuration shown in FIG. 12 by means of the same hardware configuration as that shown in FIG. 9 and a program. Specifically, the terminal management apparatus 7 includes the transmitting/receiving unit 71a, a transmitting/receiving unit 71b, and an authenticating unit 75. Furthermore, the terminal management apparatus 7 includes a storage unit 7000 built up with the HDD 204 shown in FIG. 9. In this storage unit 7000, distribution-destination selection menu data 7040, a terminal management table 7010, an available-terminal management table 7020, and electronic blackboard information 7030 are stored. The electronic blackboard information 7030 includes drawing information and electronic pen information. The terminal management apparatus 7 receives electronic blackboard information 7030 from the distribution management apparatus 2 periodically and at the end of usage of the communication terminals 5f, and stores the electronic blackboard information 7030 in the storage unit 7000. The electronic blackboard information 7030 held in the terminal management apparatus 7 is used, such as when the electronic blackboard information 7030 has been lost due to power discontinuity of the communication terminal 5f, and when one wants to use the same electronic blackboard information 7030 as last time in using the communication terminals 5f next time.

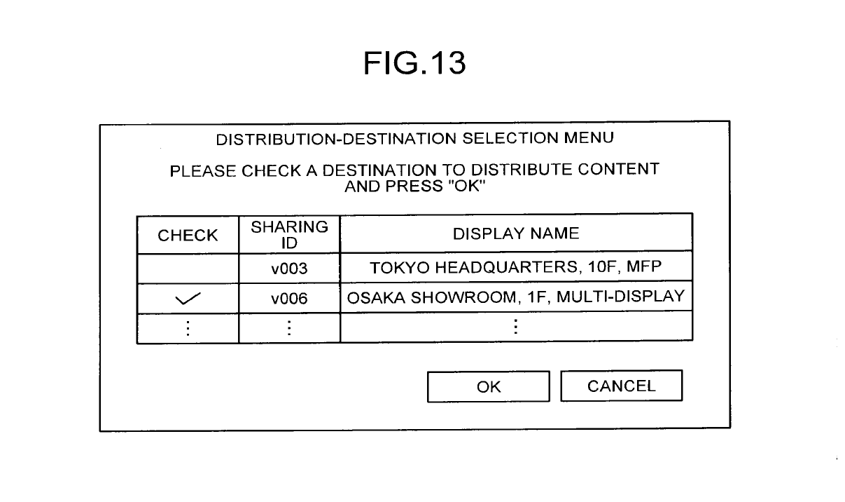

The distribution-destination selection menu data 7040 is data of a distribution-destination selection menu screen as shown in FIG. 13. FIG. 13 is a conceptual diagram of the distribution-destination selection menu screen. In the distribution-destination selection menu screen shown in FIG. 13, a list of sharing IDs and display names of communication terminals 5 that can be selected as a destination to distribute video (sound) data is displayed. A user checks an item of a desired communication terminal 5 as a destination to distribute video (sound) data and presses an “OK” button on the distribution-destination selection menu screen, and thereby the video (sound) data can be distributed to the desired communication terminal 5.

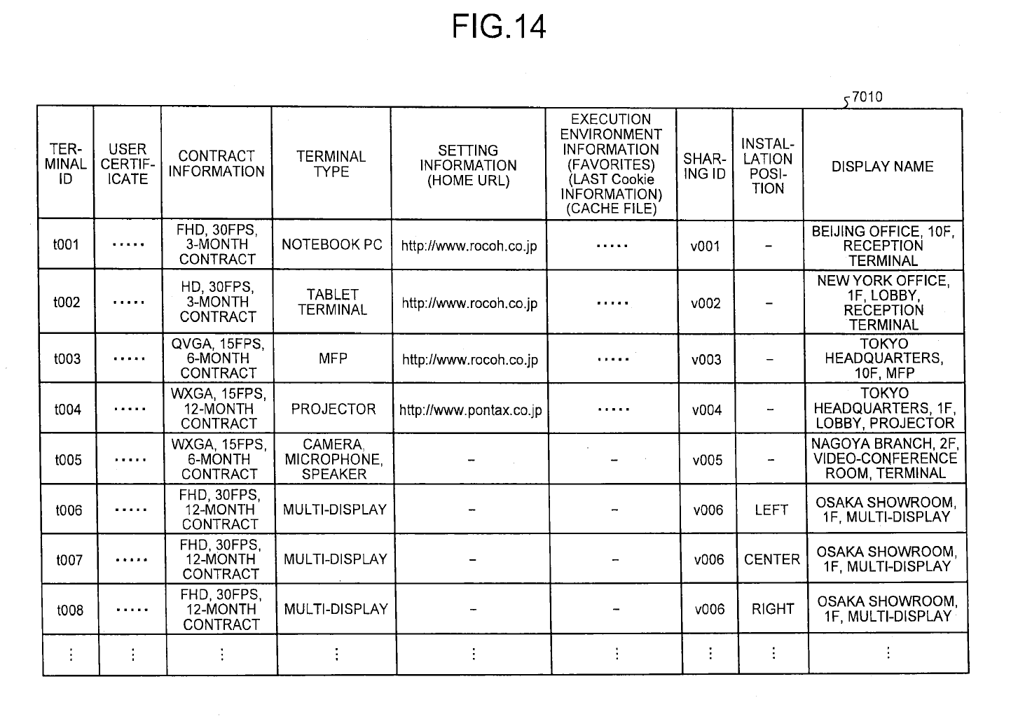

FIG. 14 is a conceptual diagram of the terminal management table 7010. In the terminal management table 7010, as shown in FIG. 14, terminal ID, user certificate, contract information on a contract for a user using the service of the distribution system 1, terminal type, setting information indicating a home URL (Uniform Resource Locator) of the communication terminal 5, execution environment information, sharing ID, installation position information, and display name information of each of registered communication terminals 5 are associated and managed. Out of these, the execution environment information includes “Favorites”, “last Cookie information”, and a “cache file” of the communication terminal 5; after the login of the communication terminal 5, the execution environment information is transmitted to the distribution management apparatus 2 together with the setting information, and is used to deliver an individual service to the communication terminal 5.

The sharing ID is an ID used in a remote sharing process in which each user distributes the same content of video (sound) data as that distributed to the user's communication terminal 5 to other communication terminals 5, and is identification information for identifying other communication terminals or other communication terminal groups. In the example shown in FIG. 14, a sharing ID of a communication terminal with terminal ID “t006” is “v006”, a sharing ID of a communication terminal with terminal ID “t007” is “v006”, and a sharing ID of a communication terminal with terminal ID “t008” is “v006”. Furthermore, when a communication terminal 5a with terminal ID “t001” has requested remote sharing with the communication terminals 5f1, 5f2, and 5f3 with sharing ID “v006”, the distribution management apparatus 2 distributes the same video (sound) data as that is being distributed to the communication terminal 5a to the communication terminals 5f1, 5f2, and 5f3. However, if the display units 58 of the communication terminals 5f1, 5f2, and 5f3 have the different resolution from the display unit 58 of the communication terminal 5a, the distribution management apparatus 2 distributes the video (sound) data according to the respective resolutions.

The installation position information indicates the installation position, for example, when the multiple communication terminals 5f1, 5f2, and 5f3 are placed side by side as shown in FIG. 7. The display name information is information representing content of display name on the distribution-destination selection menu screen shown in FIG. 13.

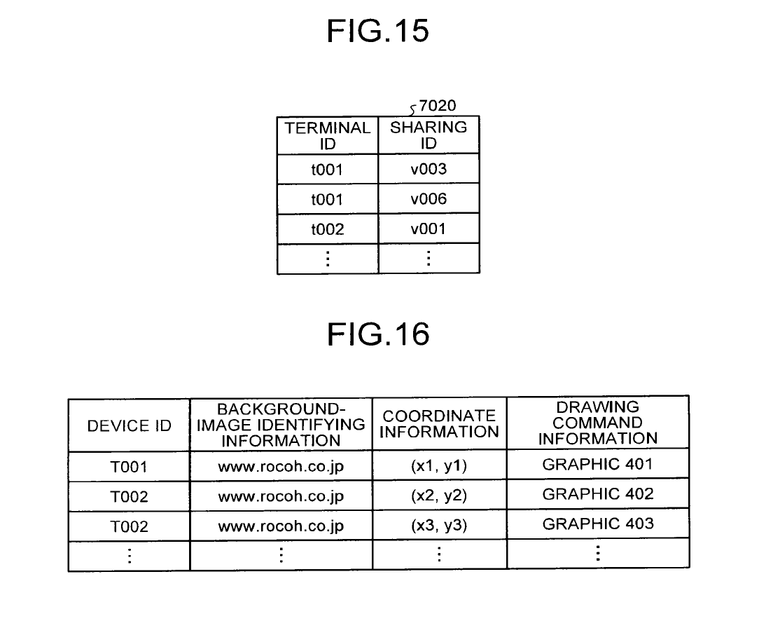

FIG. 15 is a conceptual diagram of the available-terminal management table 7020. In the available-terminal management table 7020, with respect to each terminal ID, sharing IDs of other communication terminals or other communication terminal groups with which a communication terminal 5 identified by the terminal ID can perform remote sharing are associated and managed.

FIG. 16 is a conceptual diagram showing an example of the drawing information. The drawing information includes a device ID, background-image identifying information, coordinate information, and drawing command information. The device ID is identification information for identifying a communication terminal 5f on which a user has drawn a graphic (a character, a symbol, a figure, a picture, or the like) with an electronic pen. Incidentally, in the present embodiment, a device ID is equal to a terminal ID in the terminal management table 7010. The background-image identifying information is information for identifying a background image displayed on the screen of the communication terminal 5f. For example, when a background image is a Web page, background-image identifying information is a URL of the Web page. Furthermore, when a background image is data of a document file stored in a computer, background-image identifying information is path (directory) information indicating the storage location of the document file on the computer or information indicating a file name, a page in the document file, or the like. The coordinate information is coordinates on the background image that indicates the writing start position of the graphic drawn on the screen of the communication terminal 5f with the electronic pen. The drawing command information is information indicating a command to draw the graphic drawn with the electronic pen.

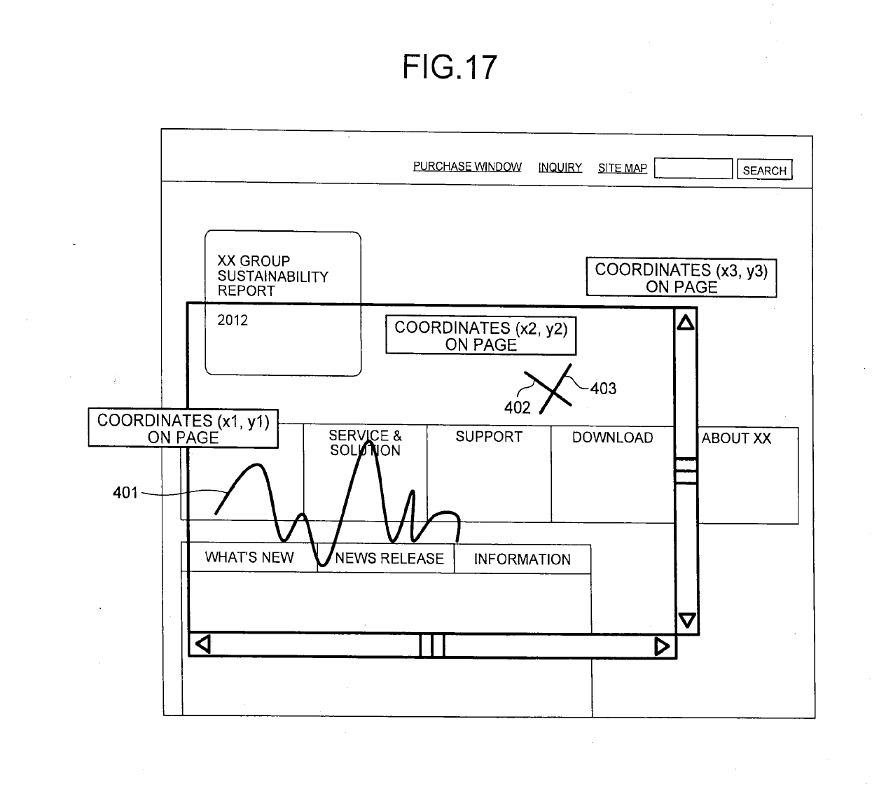

FIG. 17 is a diagram showing correspondence of the drawing information shown in FIG. 16 to the display screen of the communication terminal 5f. Data of drawing information in FIG. 16 corresponding to a graphic 401 in FIG. 17 is device ID “1001”, background-image identifying information “www.rocoh.co.jp”, coordinate information “(x1, y1)”, and a drawing command to draw the “graphic 401”. Furthermore, data of drawing information in FIG. 16 corresponding to a graphic 402 in FIG. 17 is device ID “T002”, background-image identifying information “www.rocoh.co.jp”, coordinate information “(x2, y2)”, and a drawing command to draw the “graphic 402”. Moreover, data of drawing information in FIG. 16 corresponding to a graphic 403 in FIG. 17 is device ID “T002”, background-image identifying information “www.rocoh.co.jp”, coordinate information “(x3, y3)”, and a drawing command to draw the “graphic 403”.

That is, the display screen shown in FIG. 17 is an example where the graphic 401 written on the communication terminal 5f1 identified by device ID “T001” and the graphics 402 and 403 written on the communication terminal 5f2 identified by device ID “T002” are displayed on the same screen.

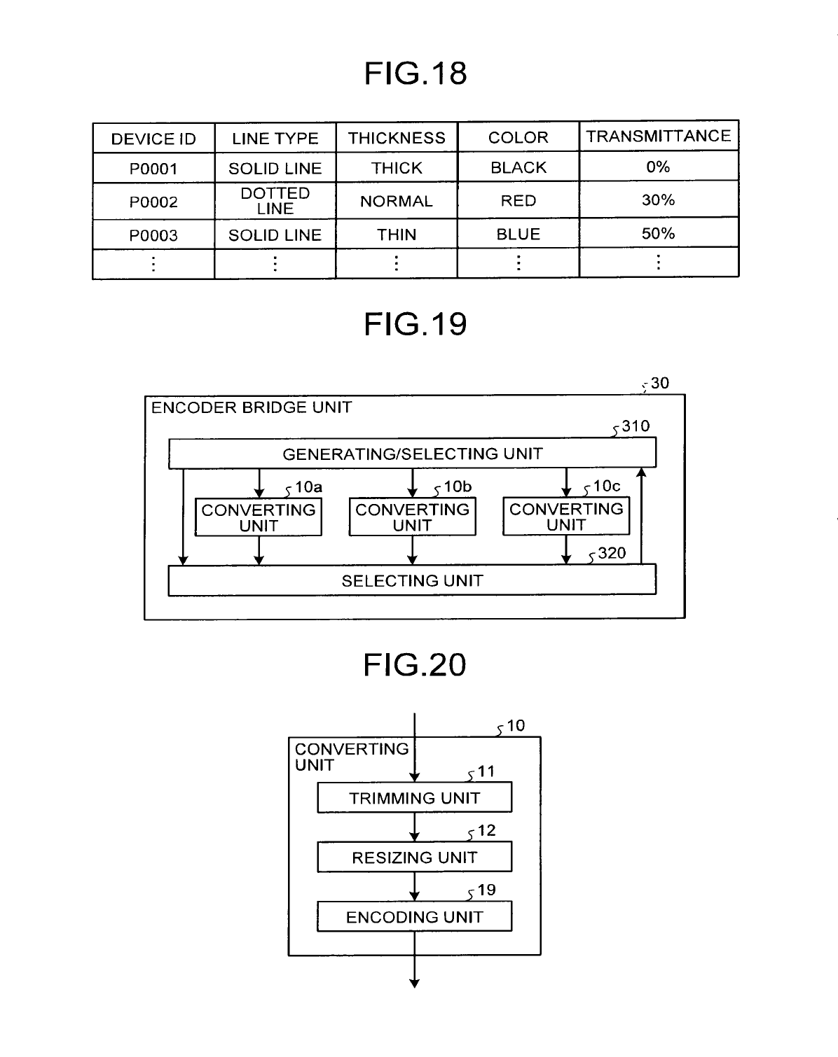

FIG. 18 is a conceptual diagram showing an example of the electronic pen information. The electronic pen information includes information on device ID, line type, thickness, color, and transmittance. The device ID is information for identifying an electronic pen used to draw a graphic. The line type is a type of line, such as a solid line and a dotted line. The thickness is thickness of the line of the graphic to be drawn. The color is color of the line of the graphic to be drawn. The transmittance is a transmittance rate of the line of the graphic to be drawn.

Returning to FIG. 12, the functional components are explained.

The transmitting/receiving unit 71a transmits/receives various data, requests, and/or the like to/from the communication terminal 5. For example, the transmitting/receiving unit 71a receives a login request including a terminal ID and a terminal certificate from the transmitting/receiving unit 51 of the communication terminal 5, and transmits a result of authentication of the login request to the transmitting/receiving unit 51.

The transmitting/receiving unit 71b transmits/receives various data, requests, and/or the like to/from the distribution management apparatus 2. For example, the transmitting/receiving unit 71b receives a request for distribution-destination selection menu data from the transmitting/receiving unit 21 of the distribution management apparatus 2, and transmits the distribution-destination selection menu data to the transmitting/receiving unit 21. Furthermore, the transmitting/receiving unit 71b receives data of electronic blackboard information 7030 from the transmitting/receiving unit 21 of the distribution management apparatus 2, and transmits data of electronic blackboard information 7030 to the transmitting/receiving unit 21.

The authenticating unit 75 searches the terminal management table 7010 on the basis of the terminal ID and user certificate received from the transmitting/receiving unit 51 of the communication terminal 5, and determines whether there is the same combination of the terminal ID and the user certificate in the terminal management table 7010, thereby authenticating the communication terminal 5a.

### Operation or Processing of Embodiment

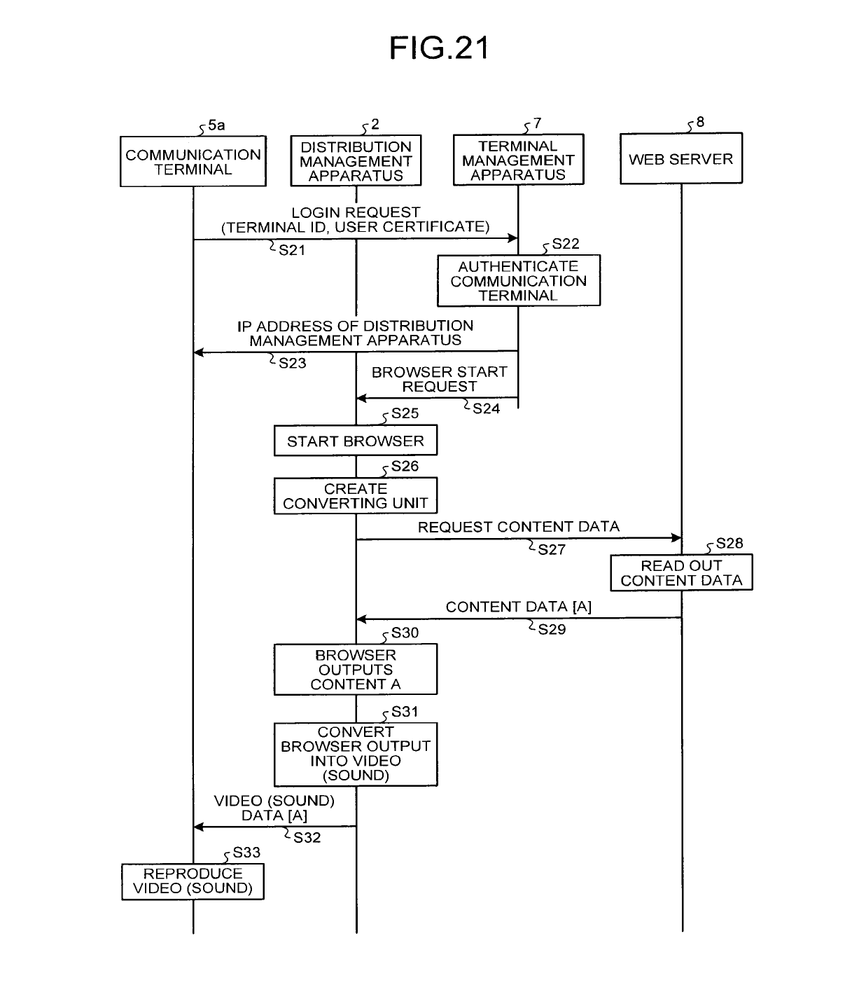

Subsequently, the operation or processing of the present embodiment is explained with FIGS. 21 to 25.

Basic Distribution Processing

First, specific distribution processing by the distribution management apparatus 2 using the basic distribution method is explained with FIG. 21. FIG. 21 is a sequence diagram showing the basic distribution processing by the distribution management apparatus 2. Here, specific processing in the basic distribution pattern shown in FIG. 6 is explained. Incidentally, here, a communication terminal 5a is used to describe a login request; however, a communication terminal 5 other than the communication terminal 5a can be used to log in

As shown in FIG. 21, when a user powers on the communication terminal 5a, the transmitting/receiving unit 51 of the communication terminal 5a transmits a login request to the authenticating unit 75 through the transmitting/receiving unit 71a of the terminal management apparatus 7 (Step S21). This login request includes a terminal ID of the communication terminal 5a and a user certificate.

Next, the authenticating unit 75 of the terminal management apparatus 7 searches the terminal management table 7010 on the basis of the terminal ID and user certificate received from the communication terminal 5a, and determines whether there is the same combination of the terminal ID and the user certificate in the terminal management table 7010, thereby authenticating the communication terminal 5a (Step S22). Here, there is described the case where there is the same combination of the terminal ID and the user certificate in the terminal management table 7010, i.e., the communication terminal 5a is authenticated to be a valid terminal in the distribution system 1.

Then, the authenticating unit 75 of the terminal management apparatus 7 transmits an IP address of the distribution management apparatus 2 to the transmitting/receiving unit 51 of the communication terminal 5a through the transmitting/receiving unit 71a (Step S23). Incidentally, the IP address of the distribution management apparatus 2 has been acquired and stored in the storage unit 7000 by the terminal management apparatus 7 in advance.

Next, the transmitting/receiving unit 71b of the terminal management apparatus 7 transmits a request to start the browser 20 to the browser managing unit 22 through the transmitting/receiving unit 21 of the distribution management apparatus 2 (Step S24). In response to this start request, the browser managing unit 22 of the distribution management apparatus 2 starts the browser 20 (Step S25). Next, the generating/selecting unit 310 of the encoder bridge unit 30 creates a converting unit 10 according to reproduction capability of the communication terminal 5a (resolution of the display or the like) and a type of content (Step S26).

Next, the browser 20 requests content data [A] from the Web server 8 (Step S27). In response to this, the Web server 8 reads out the requested content data [A] from its own storage unit (not shown) (Step S28). Then, the Web server 8 transmits the content data [A] to the requestor browser 20 through the transmitting/receiving unit 21 of the distribution management apparatus 2 (Step S29).

Next, the browser 20 renders the content data [A] thereby generating video (sound) data [A], and outputs the video (sound) data [A] to the transmission FIFO 24 (Step S30). Then, the converting unit 10 encodes the video (sound) data [A] stored in the transmission FIFO 24 thereby converting the video (sound) data [A] into video (sound) data [A] to be distributed to the communication terminal 5a (Step S31).

Then, the encoder bridge unit 30 transmits the video (sound) data [A] to the reproduction control unit 53 through the transmitting/receiving unit 31 and the transmitting/receiving unit 51 (Step S32). In the communication terminal 5a, the video (sound) data [A] is output from the reproduction control unit 53 to the decoding unit 50, and the sound is reproduced from a speaker 61, and the video is reproduced on the display unit 58 through the rendering unit 55 (Step S33).

Communication Processing using Multiple Communication Terminals

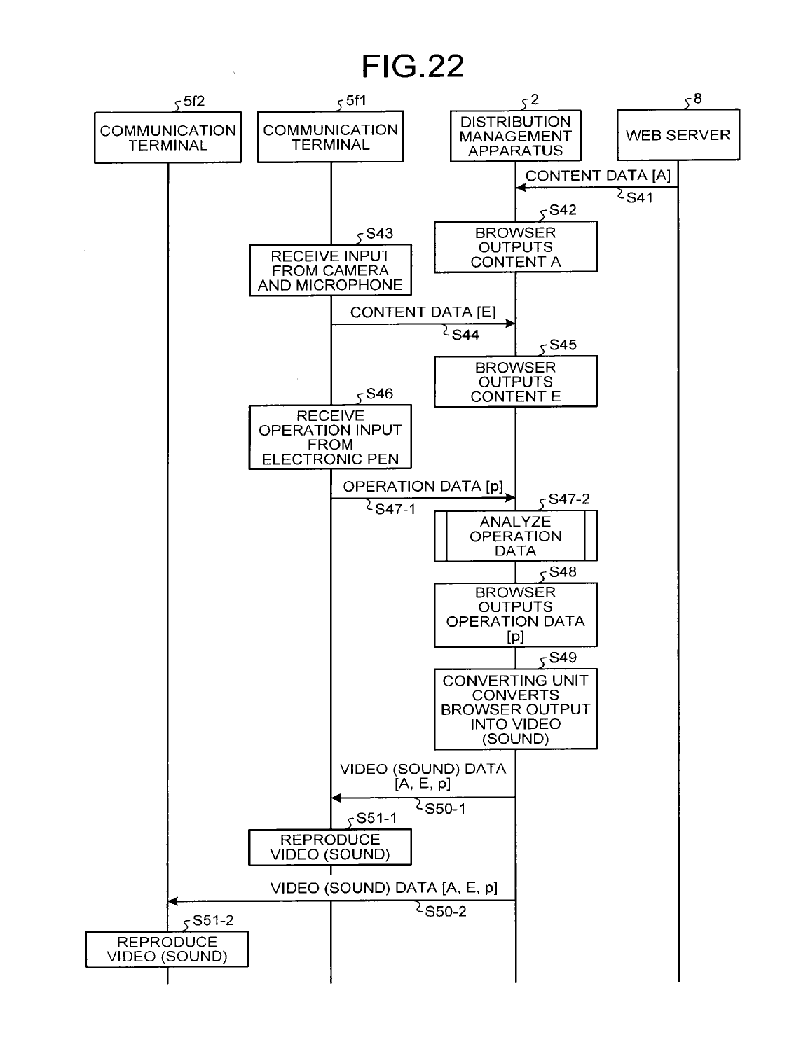

Subsequently, a remote sharing process using the distribution management apparatus 2 is explained with FIG. 22. FIG. 22 is a sequence diagram showing the remote sharing process using the distribution management apparatus 2. Here, the communication terminals 5f1 and 5f2 are taken as an example of multiple communication terminals 5, and specific processing in the pattern shown in FIG. 8 is explained. Incidentally, the same processes for login and browser start-up as Steps S21 to S29 in FIG. 21 are performed here too; however, description of processes corresponding to Steps S21 to S28 in FIG. 21 is omitted, and processes from Step S41 corresponding to Step S29 are explained below.

As shown in FIG. 22, the browser 20 of the distribution management apparatus 2 receives content data [A] from the Web server 8 through the transmitting/receiving unit 21 (Step S41). Then, the browser 20 renders the content data [A] thereby generating video (sound) data, and outputs the video (sound) data to the transmission FIFO 24 (Step S42).

On the other hand, when the encoding unit 60 of the communication terminal 5f1 has received input of content data [E] from the camera 62 and the microphone 63 (Step S43), the encoding unit 60 encodes the content data [E] and then transmits the content data [E] to the decoding unit 40 of the distribution management apparatus 2 through the transmitting/receiving unit 51 and the transmitting/receiving unit 31 (Step S44). The content data [E] is decoded by the decoding unit 40 and then input to the browser 20 through the receiving FIFO 34. Then, the browser 20 renders the content data [E] thereby generating video (sound) data [E], and outputs the video (sound) data [E] to the transmission FIFO 24 (Step S45). In this case, the browser 20 combines the content data [E] with the already-acquired content data [A] and then output the combined content data.

Furthermore, when the operation unit 52 of the communication terminal 5f1 has received input of a stroke operation of the electronic pen P1 (Step S46), the operation unit 52 transmits operation data [p] to the browser managing unit 22 through the transmitting/receiving unit 51 and the transmitting/receiving unit 31 (Step S47-1). The operation data [p] is input from the browser managing unit 22 of the distribution management apparatus 2 to the browser 20. The browser 20 analyzes the operation data [p] (Step S47-2).

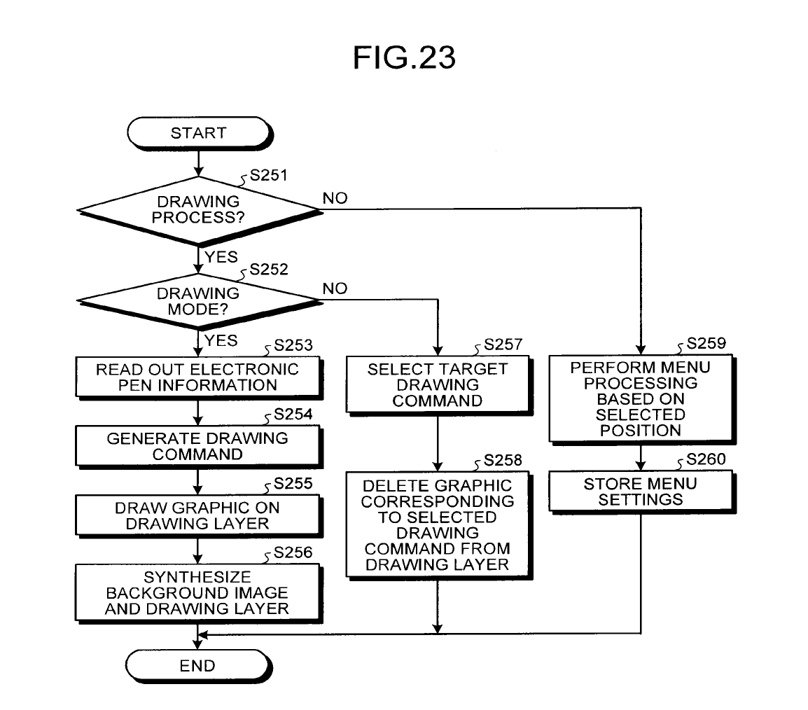

FIG. 23 is a flowchart showing the operation-data analyzing process. The browser 20 determines whether the operation data [p] is data related to a drawing process on the basis of screen-area position information included in the operation data [p] (Step S251). Here, the screen area of the communication terminal 5f is explained.

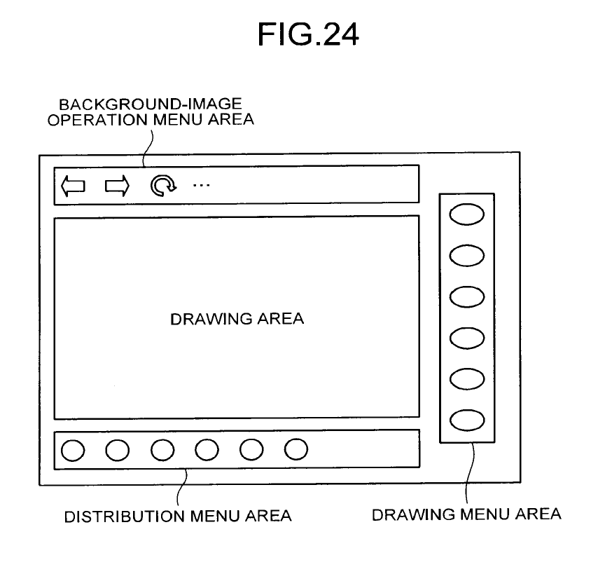

FIG. 24 is a diagram showing an example of how the screen area of the communication terminal 5f is used. In the example shown in FIG. 24, the screen area of the communication terminal 5f includes a drawing area, a background-image operation menu area, a distribution menu area, and a drawing menu area. The drawing area is an area in which a graphic can be drawn with an electronic pen. The background-image operation menu area is an area for performing an operation to change a background image. The distribution menu area is an area for performing an operation to determine a destination to distribute information drawn in the drawing area. The drawing menu area is an area for performing an operation to change the settings for drawing with the electronic pen. The settings for drawing with the electronic pen include, for example, setting of drawing mode (drawing or erasing) and setting of electronic pen information (line type, thickness, color, transmittance, and/or the like). The browser 20 determines whether the operation data [p] is data related to a drawing process on the basis of whether position information indicating the position in the screen area pointed with the electronic pen is included in the drawing area shown in FIG. 24. Incidentally, the position in the screen area pointed with the electronic pen is detected by the communication terminal 5f detecting that the electronic pen has come in contact with or close to the screen of the communication terminal 5f.

Returning to FIG. 23, when the operation data [p] is not data related to a drawing process (i.e., the operation data [p] is data related to menu processing) (NO at Step S251), the browser 20 performs menu processing on the basis of the screen-area position information (Step S259). The menu processing is, for example, a process of reflecting the setting related to change in the electronic pen information. Content of the menu processing corresponding to the position in the screen area can be stored in the storage unit 2000, for example, as menu information, and the menu information may be linked to the background image (such as the content A) so that menu processing can be changed according to content. Next, the browser 20 stores the settings changed through the menu processing in the storage unit 2000 (Step S260), and ends the process.

When the operation data [p] is data related to a drawing process (YES at Step S251), the process proceeds to Step S252. The browser 20 determines whether information indicating the operation mode included in the operation data [p] indicates the drawing mode or not (Step S252). For example, when the electronic pen has an operation-mode selector switch, the information indicating operation mode is a selection signal of the selector switch. Furthermore, the browser 20 can identify the information indicating operation mode from the setting of the drawing menu.

When the operation mode is the drawing mode (YES at Step S252), the browser 20 searches device IDs of electronic pen information in the storage unit 2000 with a device ID of the electronic pen included in the operation data [p] as a search key, and reads out retrieved electronic pen information (Step S253). Next, the browser 20 generates a drawing command from the electronic pen information and electronic-pen position information included in the operation data [p] (Step S254). Then, the browser 20 draws a graphic indicated by the drawing command on a drawing layer (Step S255). Incidentally, when a graphic has already been drawn on the drawing layer, the browser 20 adds the graphic indicated by the drawing command generated at Step S254 onto the drawing layer (differential drawing). The browser 20 outputs image data (display information) in which the background image and the drawing layer are synthesized (Step S256), and ends the process.

When the operation mode is not the drawing mode (i.e., the operation mode is the erase mode) (NO at Step S252), the browser 20 selects a drawing command corresponding to an image to be erased from position information included in the operation data (Step S257). Then, the browser 20 deletes a graphic corresponding to the selected drawing command from the image data (the drawing layer) (Step S258), and ends the process.

Returning to FIG. 22, the browser 20 outputs image data [p] in which the operation data [p] analyzed at Step S47-2 has been reflected, to the transmission FIFO 24 (Step S48). In this case, the browser 20 combines the operation data [p] with the already-acquired content data ([A], [E]), and outputs the combined data.

Next, the converting unit 10 encodes the video (sound) data ([A], [E], [p]) stored in the transmission FIFO 24 thereby converting the video (sound) data ([A], [E], [p]) into video (sound) data ([A], [E], [p]) to be distributed to the communication terminal 5a (Step S49). Then, the encoder bridge unit 30 transmits the video (sound) data ([A], [E], [p]) to the reproduction control unit 53 of the communication terminal 5f1 through the transmitting/receiving unit 31 and the transmitting/receiving unit 51 (Step S50-1). After that, the video (sound) data ([A], [E], [p]) is decoded by the decoding unit 50 of the communication terminal 5f1 to output the sound to the speaker 61, and is rendered by the rendering unit 55 to output the video onto the display unit (Step S51-1).

Also to the communication terminal 5f2, in the same manner as at Step S50-1, the encoder bridge unit 30 transmits the same video (sound) data ([A], [E], [p]) to the reproduction control unit 53 of the communication terminal 5f2 through the transmitting/receiving unit 31 and the transmitting/receiving unit 51 (Step S50-2). After that, the video (sound) data ([A], [E], [p]) is decoded by the decoding unit 50 of the communication terminal 5f2 to output the sound to the speaker 61, and is rendered by the rendering unit 55 to output the video onto the display unit (Step S51-2). Accordingly, the same video (sound) as that output onto the communication terminal 5f1 is also output onto the communication terminal 5f2.

Time Adjusting Process

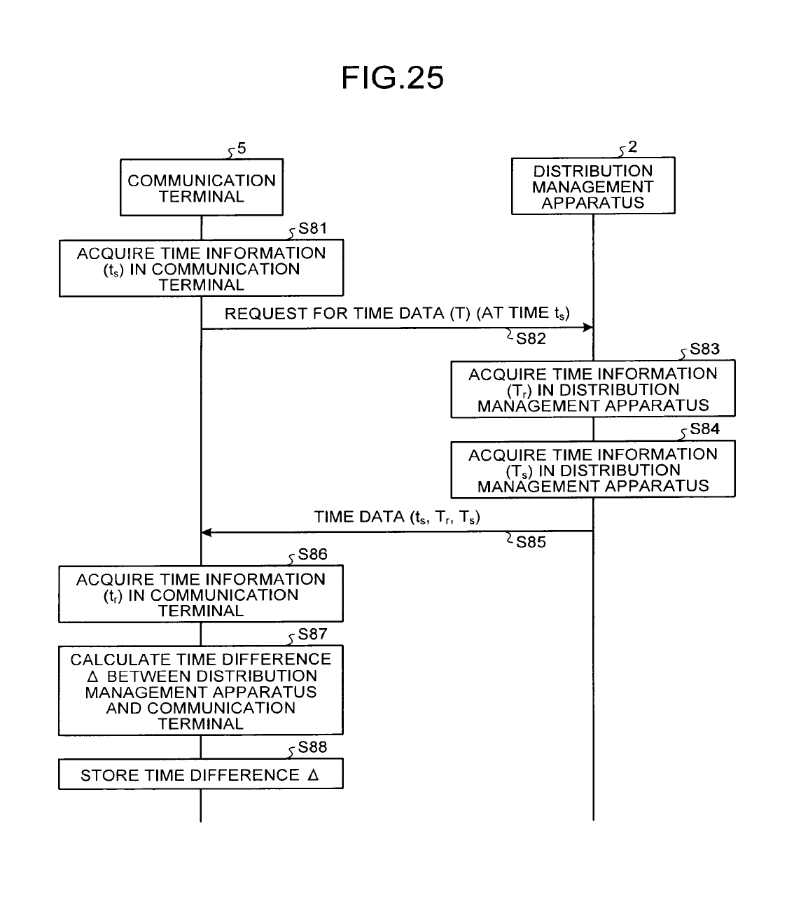

Subsequently, a time adjusting process is explained with FIG. 25. FIG. 25 is a sequence diagram showing the time adjusting process performed between the distribution management apparatus 2 and the communication terminal 5.

First, the time control unit 56 of the communication terminal 5 acquires time information (tₛ) in the communication terminal 5 from the storage unit 5000 to acquire the time for the transmitting/receiving unit 51 to request time information (T) from the distribution management apparatus 2 (Step S81). Then, the transmitting/receiving unit 51 requests time information (T) in the distribution management apparatus 2 from the transmitting/receiving unit 31 (Step S82). In this case, together with the request for time information (T), the time information (tₛ) is transmitted.

Next, the time acquiring unit 26 acquires time information (Tᵣ) in the distribution management apparatus 2 from the time managing unit 25 to acquire the time at which the transmitting/receiving unit 31 has received the request at Step S82 (Step S83). Furthermore, the time acquiring unit 26 acquires time information (Tₛ) in the distribution management apparatus 2 from the time managing unit 25 to acquire the time for the transmitting/receiving unit 31 to send a response to the request at Step S82 (Step S84). Then, the transmitting/receiving unit 31 transmits the time information ((tₛ, Tᵣ, Tₛ) to the transmitting/receiving unit 51 (Step S85).

Next, the time control unit 56 of the communication terminal 5 acquires time information (tᵣ) in the communication terminal 5 from the storage unit 5000 to acquire the time at which the transmitting/receiving unit 51 has received the response at Step S85 (Step S86).

Then, the time control unit 56 of the communication terminal 5 calculates a time difference Δ between the distribution management apparatus 2 and the communication terminal 5 (Step S87). This time difference Δ is expressed by the following equation (1).

Δ=((Tᵣ+Tₛ)/2)−((tᵣ+tₛ)/2) (1)

Then, the time control unit 56 stores time difference data Δ in the storage unit 5000 (Step S88). A series of these processes for time adjustment is periodically performed, for example, on a minute-by-minute basis.

Downlink Line Adaptive Control Process

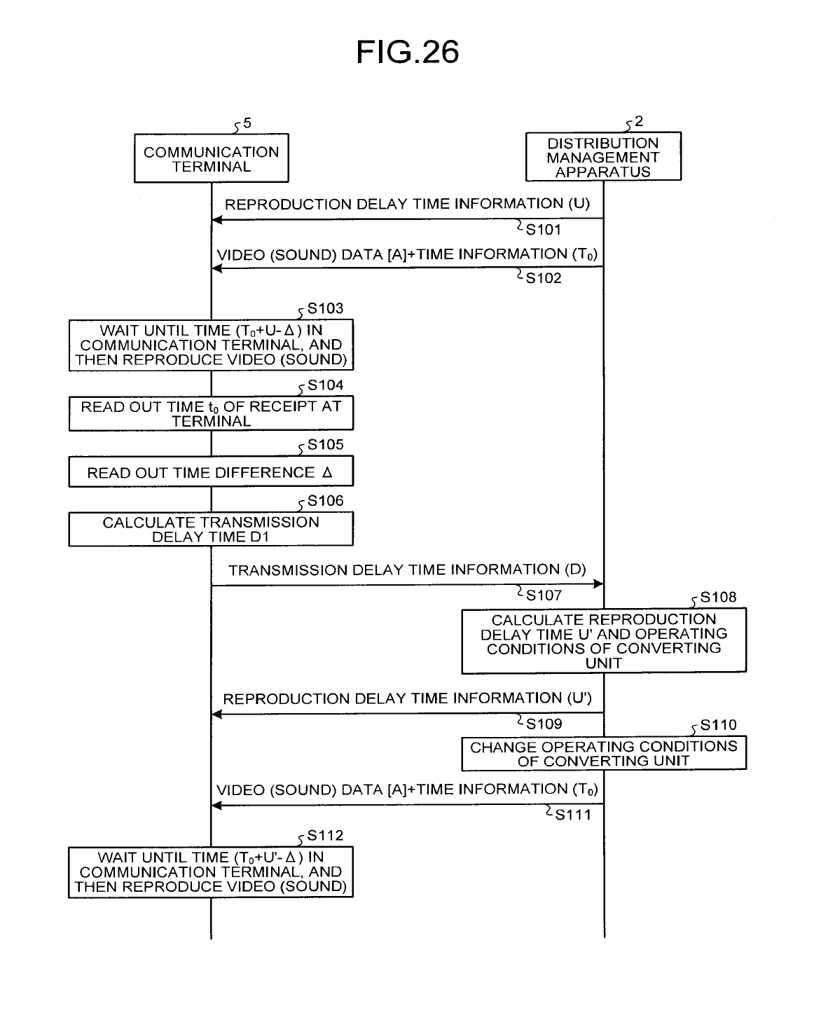

Subsequently, a process of line adaptive control for (downlink) data to be transmitted from the distribution management apparatus 2 to the communication terminal 5 is explained with FIG. 26. FIG. 26 is a sequence diagram showing the process of line adaptive control for data to be transmitted from the distribution management apparatus 2 to the communication terminal 5.

First, the encoder bridge unit 30 of the distribution management apparatus 2 transmits reproduction delay time information (U), which indicates a reproduction delay time to delay reproduction to buffer data before the reproduction, to the reproduction control unit 53 of the communication terminal 5 through the transmitting/receiving unit 31 and the transmitting/receiving unit 51 (Step S101). Furthermore, the encoder bridge unit 30 adds the current time T0 acquired from the time managing unit 25 as a time stamp to video (sound) data [A] that has been acquired from the transmission FIFO 24 and encoded, and transmits the video (sound) data [A] to the reproduction control unit 53 of the communication terminal 5 through the transmitting/receiving unit 31 and the transmitting/receiving unit 51 (Step S102).

On the other hand, in the communication terminal 5, the reproduction control unit 53 waits until the time (T₀+U−Δ) in the communication terminal 5, and then outputs the video (sound) data to the decoding unit 50, thereby the sound is reproduced from the speaker 61, and the video is reproduced on the display unit 58 through the rendering unit 55 (Step S103). That is, only the video (sound) data that the communication terminal 5 has received within a range of the reproduction delay time U expressed by the following equation (2) is reproduced, and the video (sound) data outside the range is not reproduced and is erased.

U≧(t0+Δ)−T0 (2)

The reproduction control unit 53 reads out the current time t0 in the communication terminal 5 from the storage unit 5000 (Step S104). This time t0 indicates the time in the communication terminal 5 at which the communication terminal 5 has received the video (sound) data from the distribution management apparatus 2. Furthermore, the reproduction control unit 53 reads out the time difference information (Δ) indicating the time difference Δ stored at Step S88 in FIG. 25 from the storage unit 5000 (Step S105). Then, the reproduction control unit 53 calculates a transmission delay time D1, which indicates a time between transmission of the video (sound) data from the distribution management apparatus 2 and receiving of the video (sound) data by the communication terminal 5, by using the time T0, the time t0, and the time difference Δ (Step S106). This calculation is made by the following equation (3). If the communication network 9 is congested, the transmission delay time D1 gets longer.

D1=(t0+Δ)−T0 (3)

Next, the delay-information acquiring unit 57 acquires transmission delay time information (D1) indicating the transmission delay time D1 from the reproduction control unit 53 and holds the transmission delay time information (D1) for a given length of time, and when having acquired multiple pieces of transmission delay time information (D1), the delay-information acquiring unit 57 transmits transmission delay time information (D) indicating frequency distribution information based on the multiple transmission delay times D1 to the line adaptive control unit 27 of the distribution management apparatus 2 through the transmitting/receiving unit 51 and the transmitting/receiving unit 31 (Step S107).

Next, the line adaptive control unit 27 of the distribution management apparatus 2 newly calculates a reproduction delay information U′ on the basis of the transmission delay time information (D), and calculates operating conditions, such as a frame rate and data resolution, of the converting unit 10 (Step S108).

Next, the encoder bridge unit 30 of the distribution management apparatus 2 transmits reproduction delay time information (U′) indicating the new reproduction delay time U′ calculated at Step S108 to the reproduction control unit 53 of the communication terminal 5 through the transmitting/receiving unit 31 and the transmitting/receiving unit 51 (Step S109).

Furthermore, the converting unit 10 included in the encoder bridge unit 30 changes the operating conditions on the basis of a line adaptive control signal (Step S110). For example, when the transmission delay time D1 is too long, if the reproduction delay time U is increased according to the transmission delay time D1, the time to reproduce the video (sound) data on the speaker 61 and the display unit 58 becomes too late, so there is a limit to the increase in the reproduction delay time U. Therefore, the line adaptive control unit 27 can cope with the congestion of the communication network 2 by causing the converting unit 10 to lower the frame rate of the video (sound) data and lower the resolution of the video (sound) data in addition to causing the encoder bridge unit 30 to change the reproduction delay time U to the reproduction delay time U′. Accordingly, the encoder bridge unit 30 transmits the video (sound) data added with the current time T0 as a time stamp to the reproduction control unit 53 of the communication terminal 5 as in Step S102 in accordance with the changed operating conditions (Step S111).

Next, in the communication terminal 5, the reproduction control unit 53 waits until the time (T₀+U′−Δ) in the communication terminal 5, and then outputs the video (sound) data to the decoding unit 50, thereby the sound is reproduced from the speaker 61, and the video is reproduced on the display unit 58 through the rendering unit 55 as in Step S103 (Step S112). After that, the processes from Step S104 onward are continuously performed. In this way, the downlink line adaptive control process is continuously performed.

Uplink Line Adaptive Control Process

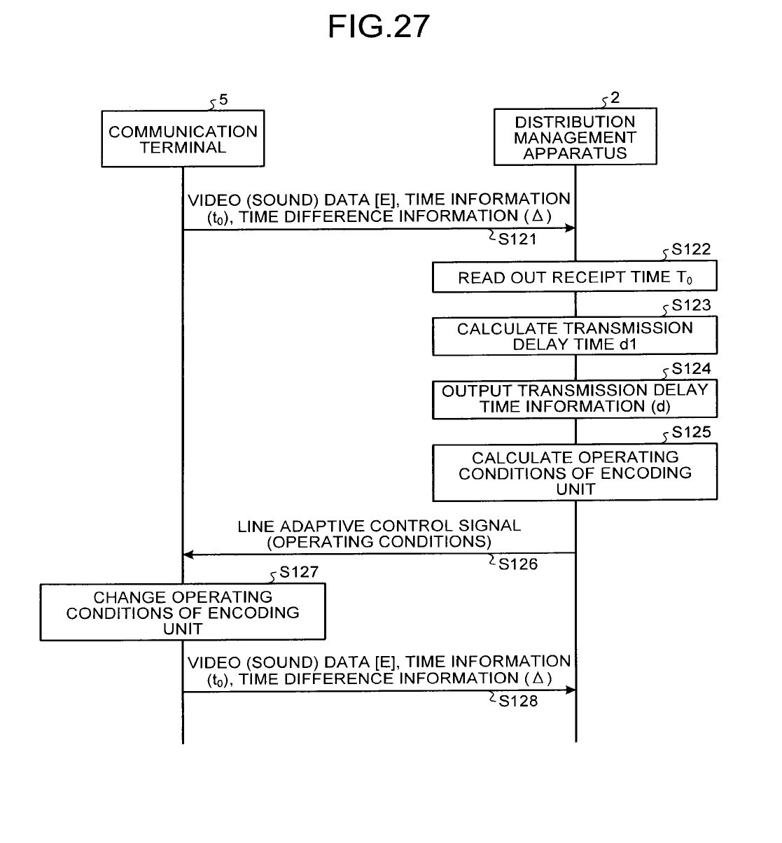

Subsequently, a process of line adaptive control for (uplink) data to be transmitted from the communication terminal 5 to the distribution management apparatus 2 is explained with FIG. 27. FIG. 27 is a sequence diagram showing the process of line adaptive control for data to be transmitted from the communication terminal 5 to the distribution management apparatus 2.

First, the encoding unit 60 of a communication terminal 5 transmits encoded video (sound) data [E] of video (sound) data acquired from the camera 62 and microphone 63, time information (t0) indicating the current time t0 in the communication terminal 5 acquired from the storage unit 5000, and time difference information (Δ) indicating a time difference Δ acquired from the storage unit 5000 to the decoding unit 40 of the distribution management apparatus 2 through the transmitting/receiving unit 51 and the transmitting/receiving unit 31 (Step S121).

Next, in the distribution management apparatus 2, the decoding unit 40 reads out the time Tₒ at which the decoding unit 40 has received the video (sound) data [E] and so on transmitted at Step S121 from the time managing unit 25 (Step S122). Then, the decoding unit 40 calculates a transmission delay time d1, which indicates a time between transmission of the video (sound) data from the communication terminal 5 and receiving of the video (sound) data by the distribution management apparatus 2 (Step S123). This calculation is made by the following equation (4). If the communication network 9 is congested, the transmission delay time d1 gets longer.

d1=T0−(t0+Δ) (4)

Next, in the same manner as the delay-information acquiring unit 57 of the communication terminal 5, the delay-information acquiring unit 37a of the distribution management apparatus 2 acquires transmission delay time information (d1) indicating the transmission delay time d1 from the decoding unit 40 and holds the acquired transmission delay time information (d1) for a given length of time, and when having acquired multiple pieces of transmission delay time information (d1), the delay-information acquiring unit 37a outputs transmission delay time information (d) indicating frequency distribution information based on the multiple transmission delay times d1 to the line adaptive control unit 37b (Step S124).

Next, the line adaptive control unit 37b calculates operating conditions of the encoding unit 60 of the communication terminal 5 on the basis of the transmission delay time information (d) (Step S125). Then, the line adaptive control unit 37b transmits a line adaptive control signal, which indicates the operating conditions such as a frame rate and data resolution, to the encoding unit 60 of the communication terminal 5 through the transmitting/receiving unit 31 and the transmitting/receiving unit 51 (Step S126). That is, the line adaptive control unit 27 in the case of downlink outputs a line adaptive control signal to the encoder bridge unit 30 inside the distribution management apparatus 2; on the other hand, the line adaptive control unit 37b in the case of uplink transmits a line adaptive control signal from the distribution management apparatus 2 to the communication terminal 5 via the communication network 9.

Next, the encoding unit 60 of the communication terminal 5 changes the operating conditions on the basis of the received line adaptive control signal (Step S127). Then, the encoding unit 60 transmits encoded video (sound) data of video (sound) data [E] acquired from the camera 62 and microphone 63, time information (t0) indicating the current time t0 in the communication terminal 5 acquired from the storage unit 5000, and time difference information (Δ) indicating a time difference Δ acquired from the storage unit 5000 to the decoding unit 40 of the distribution management apparatus 2 through the transmitting/receiving unit 51 and the transmitting/receiving unit 31 as in Step S121 in accordance with new operating conditions (Step S128). After that, the processes from Step S122 onward are continuously performed. In this way, the uplink line adaptive control process is continuously performed.

### Main Effects of Embodiment

As explained in detail above with specific examples, in the distribution system 1 according to the present embodiment, the distribution management apparatus 2 has the browser 20 and the encoder bridge unit 30 for encoding data on the cloud. Accordingly, the browser 20 generates video data or sound data from content data written in a given description language, and the encoder bridge unit 30 converts the data form of the generated data so that the data can be distributed via the communication network 9 and then distributes the data to the communication terminal 5. Therefore, the communication terminal 5 can reduce the load for receiving content data written in a given description language and the load for converting the received content data into video data or sound data; consequently, it is possible to resolve the problem of high load required to cope with the tendency that content is made richer.

Especially, the browser 20 makes real-time communication possible, and the converting unit 10 encodes video (sound) data generated by the browser 20 in real time. Therefore, unlike the case where a DVD player selects and delivers non-real-time (i.e., previously-encoded) video (sound) data as in on-demand data distribution, the distribution management apparatus 2 generates video (sound) data by rendering content acquired immediately before the distribution and encodes the video (sound) data; therefore, it is possible to perform real-time distribution of video (sound) data.

Supplemental Explanation

In the distribution system 1 according to the present embodiment, the terminal management apparatus 7 and the distribution management apparatus 2 are configured as separate apparatuses; however, the terminal management apparatus 7 and the distribution management apparatus 2 can be configured to be integrated into one apparatus, for example, in such a manner that the distribution management apparatus 2 has the functions of the terminal management apparatus 7.

Furthermore, each of the distribution management apparatus 2 and the terminal management apparatus 7 according to the above-described embodiment can be built up with a single computer, or can be built up with multiple computers arbitrarily assigned to respective units (functions, means, or storage units) into which the units (functions, means, or storage units) of each apparatus are divided.

Moreover, recording media, such as CD-ROM, and the HDD 204 that have stored therein the program according to the above-described embodiment can be provided to domestic and overseas as program products.

According to an embodiment, it is possible to display, on a terminal, a drawn image handwritten by a user without delay at low cost.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A distribution management apparatus comprising:
a receiving unit that receives operation information, which indicates operation input that a terminal has accepted, from the terminal via a network;
a browser that creates drawing information to be displayed on the terminal from the operation information;
an encoder that encodes the drawing information; and
a transmitting unit that transmits the encoded drawing information to the terminal.

2. The distribution management apparatus according to claim 1, wherein
the operation information further includes identification information that identifies the terminal,
the distribution management apparatus further comprises a storage unit that stores therein the drawing information and the identification information in an associated manner, and
the transmitting unit transmits encoded drawing information to the terminal identified by identification information associated with the drawing information.

3. The distribution management apparatus according to claim 1, wherein
the operation information further includes coordinate information on coordinates on a display screen of the terminal, and
the browser creates the drawing information or changes drawing setting information of the terminal on the basis of the coordinate information.

4. The distribution management apparatus according to claim 3, wherein
the drawing setting information includes thickness of a line, color of the line, and a type of the line.

5. The distribution management apparatus according to claim 3, wherein
the browser creates a drawing command on the basis of the coordinate information included in the operation information and the drawing setting information and creates the drawing information on the basis of the drawing command.

6. The distribution management apparatus according to claim 1, wherein
the operation information further includes drawing mode information indicating either drawing or erasing, and
the browser creates or erases the drawing information on the basis of the drawing mode information.

7. The distribution management apparatus according to claim 1, wherein
the receiving unit further receives content from a Web server via network,
the browser displays display information in which the drawing information is superimposed on the content,
the encoder encodes the display information, and
the transmitting unit transmits the encoded display information to the terminal.

8. The distribution management apparatus according to claim 7, wherein
the storage unit stores therein the drawing information and a position of the drawing information on the content in an associated manner.
